(19) United States
(12) Patent Application Publication
(10) Pub. No.: US 2026/0254731 A1
(43) Pub. Date: Aug. 27, 2026

(54) NETWORK VIRTUAL FUNCTION HEALTH MONITORING

(71) Applicant: Boost SubscriberCo L.L.C., Englewood, CO (US)

(72) Inventors: Vinay W. Tiwari, Lone Tree, CO (US); Madhu Sowmya Bandi, Englewood, CO (US); Xinyu Lou, Lone Tree, CO (US); Shubham Singh, Lone Tree, CO (US)

(21) Appl. No.: 19/065,653

(22) Filed: Feb. 27, 2025

(51) Int. Cl. H04L 41/00; G06F 40/295; G06F 40/30; H04L 41/22

(52) U.S. Cl. CPC H04L 41/20; G06F 40/295; G06F 40/30; H04L 41/22

(57) ABSTRACT

A disclosed method may include (i) receiving, by a cellular network health monitoring software tool, a natural language query from an agent of a mobile operator operating a fifth or later generation cellular network regarding operational status of a network function on the fifth or later generation cellular network and (ii) vectorizing, by the cellular network health monitoring software tool, the natural language query through vector embedding such that the query is standardized.

### BRIEF SUMMARY

This disclosure is generally directed to systems, methods, and computer-readable media relating to network virtual function health monitoring. In the rapidly evolving landscape of cellular networks, the transition to fifth-generation (5G) technology and beyond brings challenges and opportunities for network operators. The increased complexity of advanced cellular infrastructure, with its multiple network functions and dynamic resource allocation, may create new challenges in identifying and resolving network issues promptly. Network operators may face difficulties in maintaining optimal performance across various network functions, potentially leading to service degradation and customer dissatisfaction. In response to these challenges, innovative techniques for network health monitoring may be developed to leverage advanced technologies such as artificial intelligence and machine learning. These techniques may provide network operators with more efficient and effective tools for managing the complexities of modern cellular networks, enabling them to proactively identify and address potential issues before they impact service quality. Additionally, as the industry looks towards 6G and beyond, these monitoring techniques may need to evolve further to accommodate even more complex network architectures, higher data rates, and more diverse use cases. The development of such advanced monitoring techniques may play a pivotal role in ensuring the reliability and performance of future cellular networks, supporting the increasing demands of emerging technologies such as autonomous vehicles, smart cities, and the Internet of Things.

One significant challenge in managing advanced cellular networks may be the sheer volume of data generated by network logs and monitoring systems. With numerous network functions operating simultaneously across multiple locations, the amount of data produced may be overwhelming for human operators to process effectively. This data overload may lead to delays in identifying issues, potentially resulting in prolonged service disruptions or suboptimal network performance. Additionally, the complexity of modern cellular networks may make it difficult for operators to quickly pinpoint the root cause of performance issues, as problems in one network function may have cascading effects on others. To address these challenges, a technique for efficient data processing and analysis may be implemented, utilizing advanced algorithms to sift through vast amounts of network data and identify patterns or anomalies that may indicate potential issues. This technique may involve the use of machine learning models trained on historical network data to recognize patterns associated with various types of network problems. By automating the initial stages of data analysis, this technique may significantly reduce the time and effort required for network operators to identify and diagnose issues. Furthermore, the system may employ predictive analytics to anticipate potential network problems before they occur, allowing operators to take preemptive action to maintain optimal network performance. As cellular networks continue to evolve and become more complex, these data processing and analysis techniques may need to adapt accordingly, potentially incorporating more sophisticated AI algorithms and leveraging increased computational power to handle even larger volumes of data generated by future network architectures.

Another challenge in managing advanced cellular networks may be the desire for real-time monitoring and rapid response to network issues. As these networks support an increasing number of mission-critical applications, such as autonomous vehicles and remote surgeries, even minor network disruptions may have severe consequences. Monitoring techniques that rely on periodic reports or manual analysis may not provide the immediacy required in such scenarios. Moreover, the dynamic nature of modern cellular networks, with their ability to reconfigure resources on the fly, may further complicate the task of maintaining consistent performance across all network functions. To overcome these challenges, a real-time monitoring system may be developed that utilizes advanced data analytics and machine learning algorithms to provide instantaneous insights into network health and performance. This system may continuously analyze incoming network data streams, using sophisticated pattern recognition techniques to identify anomalies or potential issues as they emerge. The real-time monitoring capability may be complemented by an automated alert system that notifies network operators of issues that may benefit from immediate attention. Additionally, the system may incorporate predictive modeling to forecast potential network congestion or failures based on current usage patterns and historical data. This proactive approach may allow network operators to take preventive measures before issues escalate, potentially reducing downtime and improving overall network reliability. As cellular networks evolve towards 6G and beyond, the real-time monitoring system may need to adapt to handle even higher data rates and more complex network topologies, potentially incorporating edge computing and distributed AI techniques to process data closer to its source and reduce latency in issue detection and response.

The virtualization of network functions in advanced cellular architectures may introduce additional complexities in network monitoring and troubleshooting. Unlike physical hardware, virtual network functions may be more dynamic and distributed, making it challenging to track their performance and interdependencies. This virtualized environment may also introduce types of issues, such as resource contention or misconfiguration of virtual components, which may not be easily detectable using certain monitoring tools. Furthermore, the abstraction layer introduced by virtualization may make it more difficult for network operators to correlate observed issues with specific underlying hardware or software components. To address these challenges, a comprehensive monitoring solution may be developed that integrates seamlessly with virtualized network environments, providing visibility into both virtual and physical components of the cellular infrastructure. This solution may employ sophisticated mapping techniques to maintain a real-time view of the relationships between virtual network functions and the underlying physical resources they utilize. By maintaining this comprehensive view of the network architecture, the monitoring system may be better equipped to identify the root causes of performance issues, even in complex virtualized environments. The system may also incorporate AI-driven anomaly detection algorithms specifically designed to identify issues unique to virtualized networks, such as VM migration problems or resource allocation conflicts. As cellular networks continue to evolve, with potential advancements in network function virtualization and software-defined networking in 6G and beyond, this monitoring solution may benefit from adapting to even more dynamic and flexible network architectures. This may involve the development of more sophisticated modeling techniques to represent and analyze increasingly complex virtual network topologies and their interactions with physical infrastructure.

In response to these challenges, a technique for cellular network health monitoring may be developed that leverages the power of artificial intelligence and natural language processing. This technique may utilize a sophisticated software tool that allows network operators to interact with the monitoring system using natural language queries. By employing advanced language models and machine learning algorithms, the system may interpret complex queries about network health and performance, translating them into specific data retrieval and analysis tasks. This natural language interface may significantly reduce the learning curve for network operators and enable them to quickly obtain relevant insights without the need for specialized programming skills or in-depth knowledge of query languages. The system may be designed to understand a wide range of network-related terminology and concepts, allowing operators to phrase their queries in a manner that feels natural and intuitive. For example, an operator may ask, “What is the current performance of the N6 function in the downtown area?” and the system may interpret this query, retrieve the relevant data, and present the results in a clear and concise manner. As the system processes more queries over time, it may learn from these interactions and improve its understanding of user intent, potentially offering more accurate and relevant responses. Additionally, the natural language processing capabilities may extend beyond simple query interpretation to include more advanced features such as conversational AI, allowing operators to engage in a dialogue with the system to refine their queries or explore related network issues. This conversational interface may prove particularly valuable in complex troubleshooting scenarios, where the root cause of a problem may not be immediately apparent and may require iterative investigation. As cellular networks evolve towards 6G and beyond, this natural language interface may need to adapt to incorporate new network concepts and terminology, potentially leveraging more advanced AI models to handle increasingly complex and nuanced queries about network performance and health.

In some examples, a method includes (i) receiving, by a cellular network health monitoring software tool, a natural language query from an agent of a mobile operator operating a fifth or later generation cellular network regarding operational status of a network function on the fifth or later generation cellular network, (ii) vectorizing, by the cellular network health monitoring software tool, the natural language query through vector embedding such that the query is standardized, (iii) determining whether the standardized query is cached, (iv) performing, in response to determining whether the standardized query is cached: retrieving, based on determining that the standardized query is cached, a cached response of previously generated code from a network status query database or applying, based on determining that the standardized query is not cached, a generative artificial intelligence model to the natural language query such that newly generated code is generated, and (v) presenting, via the graphical user interface to the agent of the mobile operator, a response to executing the previously generated code from the cached response or the newly generated code such that a status of the network function is indicated.

In some examples, the method further comprises applying a data input layer that receives data for processing by the cellular network health monitoring software tool.

In some examples, the data input layer comprises a user input interface that receives the natural language query or a log file interface that receives network log data.

In some examples, the method further comprises applying a pre-processing layer that transforms log data for subsequent analysis by a modeling layer.

In some examples, the pre-processing layer comprises a data cleaning operation that removes errors from the log data, a data storage operation that structures the cleaned log data into a dataframe for efficient processing, or a pattern mining operation that identifies recurring patterns in the log data.

In some examples, the previously generated code from the cached response or the newly generated code is executed by a modeling layer.

In some examples, the modeling layer comprises a code generation operation or a code execution operation.

In some examples, the code generation operation comprises a caching operation that performs text embedding on the standardized query such that semantic meaning is captured in a vector space, a caching operation that calculates a similarity score between the standardized query and cached queries such that similar past queries are identified, a smart search operation that performs named entity recognition on the standardized query such that a recognized name from the query is identified, or a large language model-based code generation operation that generates a dataframe or chart based on the standardized query at least in part by translating the query into executable code.

In some examples, the modeling layer comprises a code testing operation that removes jailbreaking attempts, unsafe scripts, or non-whitelisted libraries such that a safety level of executing code is improved, a code execution operation that runs the previously generated code or the newly generated code on the network log data, or a cache updating operation that stores the standardized query and corresponding generated code for future use.

In some examples, the method further comprises applying a graphical user interface layer that presents the response indicating the status of the network function to the agent of the mobile operator.

In some examples, wherein the graphical user interface layer comprises a network function selection prompt, a segmentation order selection prompt, a time window selection prompt, a domain name system selection prompt, or a data source selection prompt.

In some examples, the graphical user interface layer comprises a heat map that visually represents the status of the network function indicated in the response.

In some examples, the heat map is indexed along one dimension by date or by location of a data center.

In some examples, the graphical user interface layer displays the original natural language query.

In some examples, the graphical user interface layer displays a chart indicating a pass rate per location for the network function.

In some examples, the graphical user interface layer comprises a feedback prompt asking whether the response was helpful or a chatbot dialogue interface for further queries.

In some examples, a non-transitory computer-readable medium has instructions stored thereon that, when executed by at least one physical computing processor, cause a computing device to perform operations comprising (i) receiving, by a cellular network health monitoring software tool, a natural language query from an agent of a mobile operator operating a fifth or later generation cellular network regarding operational status of a network function on the fifth or later generation cellular network, (ii) vectorizing, by the cellular network health monitoring software tool, the natural language query through vector embedding such that the query is standardized, (iii) determining whether the standardized query is cached, (iv) performing, in response to determining whether the standardized query is cached: retrieving, based on determining that the standardized query is cached, a cached response of previously generated code from a network status query database or applying, based on determining that the standardized query is not cached, a generative artificial intelligence model to the natural language query such that newly generated code is generated, and (v) presenting, via the graphical user interface to the agent of the mobile operator, a response to executing the previously generated code from the cached response or the newly generated code such that a status of the network function is indicated.

In some examples, a system comprises at least one physical computing processor of a computing device and a non-transitory computer-readable medium that has instructions stored thereon that, when executed by the at least one physical computing processor, cause the computing device to perform operations comprising (i) receiving, by a cellular network health monitoring software tool, a natural language query from an agent of a mobile operator operating a fifth or later generation cellular network regarding operational status of a network function on the fifth or later generation cellular network, (ii) vectorizing, by the cellular network health monitoring software tool, the natural language query through vector embedding such that the query is standardized, (iii) determining whether the standardized query is cached, (iv) performing, in response to determining whether the standardized query is cached: retrieving, based on determining that the standardized query is cached, a cached response of previously generated code from a network status query database or applying, based on determining that the standardized query is not cached, a generative artificial intelligence model to the natural language query such that newly generated code is generated, and (v) presenting, via the graphical user interface to the agent of the mobile operator, a response to executing the previously generated code from the cached response or the newly generated code such that a status of the network function is indicated.

### BRIEF DESCRIPTION OF THE DRAWINGS

For a better understanding of the present invention, reference will be made to the following Detailed Description, which is to be read in association with the accompanying drawings:

FIG. 1 shows an example flow diagram for a method relating to network virtual function health monitoring.

FIG. 2 is a block diagram depicting a solution design and architecture for a cellular network health software tool, in accordance with some examples described herein.

FIG. 3 is a diagram showing a detailed dashboard output with a heat map representation of network function status, in accordance with some examples described herein.

FIG. 4 is a diagram illustrating a pass rate chart with a natural language query interface, in accordance with some examples described herein.

FIG. 5 is a diagram depicting a real-world network operations center environment where the cellular network health software tool may be utilized, in accordance with some examples described herein.

FIG. 6 is a flow diagram illustrating a detailed process of query handling and code generation within the cellular network health software tool, in accordance with some examples described herein.

FIG. 7 is a block diagram showing a detailed representation of a pre-processing layer for network log data analysis, in accordance with some examples described herein.

FIG. 8 is a diagram illustrating a detailed representation of the graphical user interface for the cellular network health software tool, in accordance with some examples described herein.

FIG. 9 is a flow diagram depicting the code generation and execution process within the cellular network health software tool, in accordance with some examples described herein.

FIG. 10 is a diagram showing a real-world scenario of 5G network troubleshooting using the cellular network health software tool, in accordance with some examples described herein.

FIG. 11 shows a diagram of an example computing system that may facilitate the performance of one or more of the methods described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

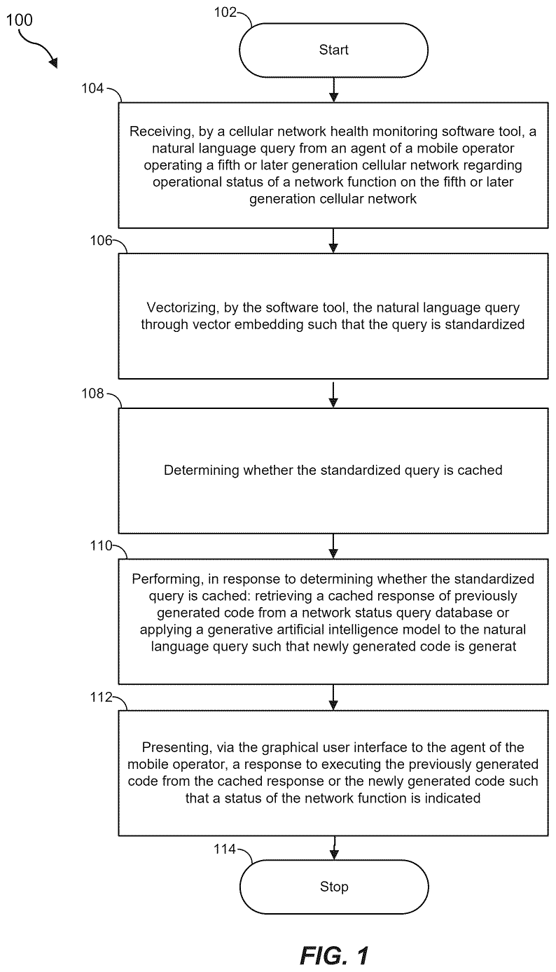

FIG. 1 shows a flow diagram for a method 100 relating to monitoring network health in a fifth or later generation cellular network. At step 102, method 100 may start. At step 104, method 100 includes receiving, by a cellular network health software tool, a natural language query from an agent of a mobile operator operating a fifth or later generation cellular network regarding operational status of a network function on the fifth or later generation cellular network. At step 106, method 100 includes vectorizing, by the cellular network health monitoring software tool, the natural language query through vector embedding such that the query is standardized. At step 108, method 100 includes determining whether the standardized query is cached. At step 110, method 100 includes performing, in response to determining whether the standardized query is cached: retrieving, based on determining that the standardized query is cached, a cached response of previously generated code from a network status query database; or applying, based on determining that the standardized query is not cached, a generative artificial intelligence model to the natural language query such that newly generated code is generated. At step 112, method 100 includes presenting, via the graphical user interface to the agent of the mobile operator, a response to executing the previously generated code from the cached response or the newly generated code such that a status of the network function is indicated. At step 114, method 100 ends.

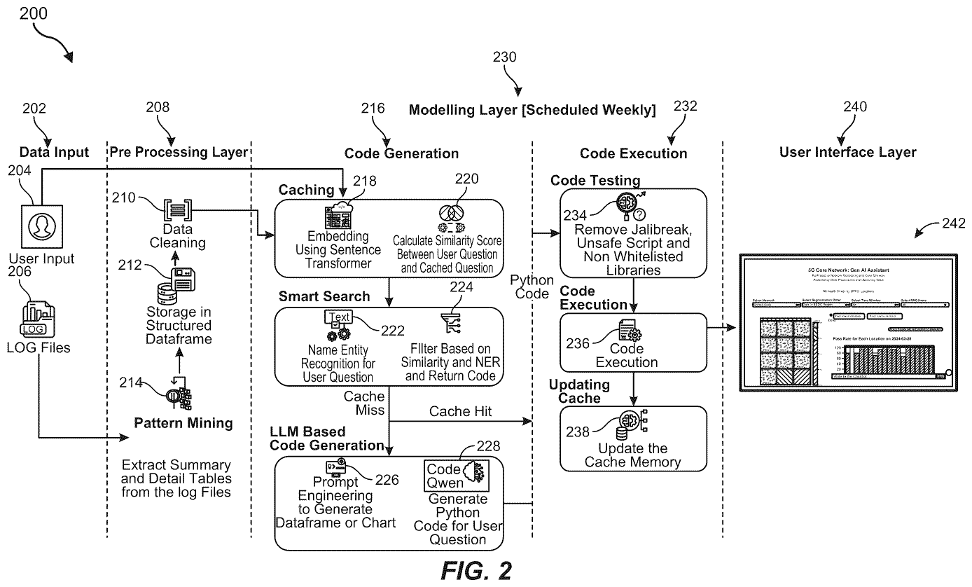

FIG. 2 illustrates an example solution design and architecture 200 for a cellular network health software tool. The architecture 200 shows several interconnected components that may work together to process network data, handle user queries, and/or provide insights into network health. These components may be organized into five main sections: data input 202, preprocessing layer 208, code generation 216, code execution 232, and/or user interface 240. These sections may operate within a broader modeling layer 230, which may be scheduled to run on a weekly basis or at other suitable intervals. The modeling layer 230 may serve as an overarching framework that coordinates the activities of the various components, ensuring that they work in harmony to provide comprehensive network health analysis. This weekly scheduling may allow for regular updates and trend analysis, while also providing flexibility to adjust the frequency based on the specific preferences of the network operator. The architecture 200 may be designed to handle the complex and dynamic nature of advanced cellular networks, potentially accommodating the evolving requirements of 5G, 6G, and/or future network technologies.

The data input section 202 may serve as the entry point for information into the system. It may comprise two primary sources: user input 204 and/or log files 206. User input 204 may include natural language queries or specific requests from network operators seeking information about network health. These queries may range from simple status checks to complex analytical questions about network performance trends. The system may be designed to interpret and process a wide variety of user inputs, potentially accommodating different levels of technical expertise among operators. Log files 206 may contain raw data from various network components, capturing performance metrics, error messages, and/or other relevant information about the network's operation. These log files may be generated by multiple sources within the network infrastructure, potentially including base stations, core network components, and/or user equipment. The diversity of data sources may contribute to a comprehensive view of network health, allowing for detailed analysis and troubleshooting across different aspects of the network.

The preprocessing layer 208 may be responsible for preparing the raw data for analysis. This layer may include several sub-components that work in concert to refine and structure the input data. The data cleaning component 210 may remove inconsistencies, errors, or irrelevant information from the raw data. This process may involve techniques such as noise reduction, outlier detection, and/or data normalization to facilitate the quality and consistency of the data used for analysis. The storage and structured data frame component 212 may organize the cleaned data into a format that is optimized for efficient querying and analysis. This may involve creating indexed databases, implementing data partitioning strategies, and/or designing schema that facilitate rapid data retrieval and processing. The pattern mining component 214 may identify recurring patterns or trends in the data that may be indicative of network issues or performance characteristics. This component may employ various data mining algorithms, potentially including clustering, association rule mining, and/or time series analysis, to uncover hidden patterns in the network data. These components may work iteratively, with data flowing between them as needed to achieve the desired level of data quality and structure. The preprocessing layer 208 may play a crucial role in transforming raw, unstructured network data into a format that is suitable for advanced analysis and machine learning techniques.

The code generation 216 may be a central component of the architecture, responsible for translating user queries into executable code. This section may employ several sophisticated techniques to handle queries efficiently. The caching subsystem may utilize embedding using sentence transformers 218 to convert natural language queries into a mathematical representation. This embedding process may allow for the comparison of queries based on their semantic meaning rather than just their textual similarity. It may then calculate similarity scores between the user's question and previously cached questions 220, potentially allowing for rapid retrieval of results for similar queries. This caching mechanism may significantly improve response times for frequently asked questions or queries that are semantically similar to previous ones. If a cache miss occurs, the smart search component may engage, employing named entity recognition 222 to identify key elements of the user's question. This may involve identifying specific network components, locations, time periods, or other relevant entities mentioned in the query. It may then filter based on similarity and named entity recognition to return relevant code 224. This step may help in narrowing down the search space and identifying the most appropriate pre-existing code snippets or templates to answer the user's query. In cases where no suitable cached response is found, the system may resort to LLM-based code generation. This may involve prompt engineering to generate a data frame or chart 226 based on the query, or directly generating code (e.g., Python code) to answer the user's question 228. The LLM-based generation may leverage advanced natural language processing models to interpret the user's intent and generate appropriate code, potentially adapting to complex or novel queries that may not have been anticipated in the system's initial design.

The code execution section 232 may be responsible for safely running the generated or retrieved code and producing results. It may begin with a code testing phase 234, which may remove potential security threats such as jailbreak attempts, unsafe scripts, or calls to non-whitelisted libraries. This security check may be helpful in maintaining the integrity and safety of the network management system, particularly when dealing with automatically generated code. Once the code passes these safety checks, it may be executed 236. The execution environment may be carefully controlled to prevent any unintended impacts on the live network while still allowing access to necessary data and resources. The results of this execution may then be used to update the cache 238, potentially improving response times for similar future queries. This continuous learning and updating process may allow the system to become more efficient over time, adapting to the specific patterns of queries and network issues encountered by the operators.

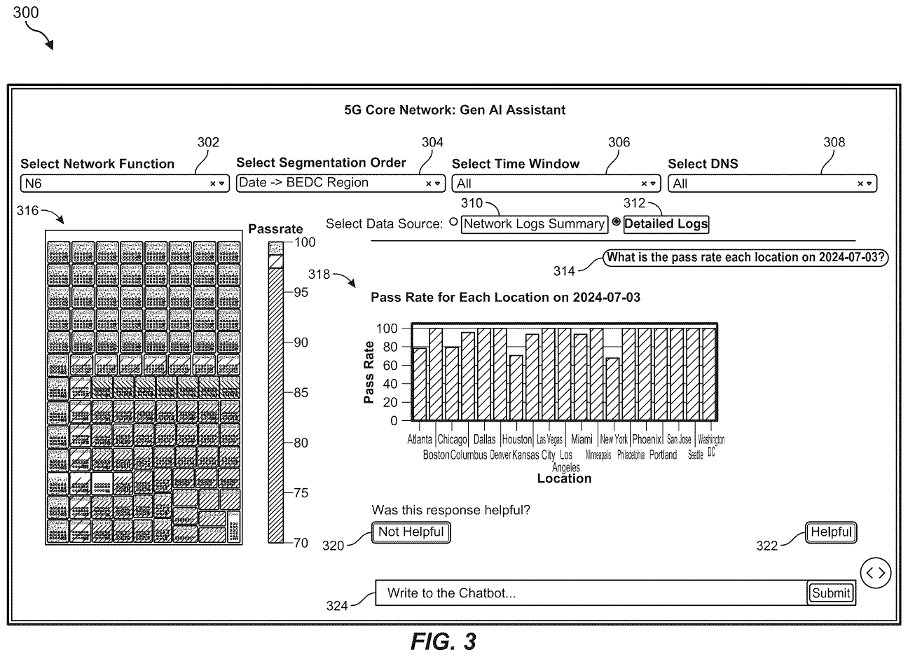

Finally, the user interface layer 240 may present the results to the user in an intuitive and informative manner. This may include a dashboard 242 that visualizes network health data, potentially similar to the heat map representation shown in FIG. 3. The dashboard may provide a high-level overview of network status, potentially using color-coding or other visual cues to quickly communicate the health of different network components or regions. The user interface may provide an interactive experience, allowing users to drill down into specific areas of interest or refine their queries based on initial results. This interactivity may enable network operators to explore the data dynamically, potentially uncovering insights that may not be immediately apparent from static reports. The user interface layer 240 may also include features such as customizable alerts, trend analysis tools, and/or the ability to export data for further analysis in external tools. By presenting complex network health information in a user-friendly manner, the interface may help bridge the gap between raw data and actionable insights, potentially improving the efficiency and effectiveness of network management operations.

In some examples, the data cleaning process 210 may involve a wide array of techniques beyond those explicitly shown in FIG. 2. Data cleaning may encompass methods such as noise reduction, outlier detection, missing value imputation, and/or data normalization. For instance, the system may employ advanced statistical methods to identify and remove anomalous data points, potentially utilizing techniques like Z-score analysis, Interquartile Range (IQR) calculations, or machine learning-based anomaly detection algorithms. In the case of missing value imputation, the system may use sophisticated techniques such as multiple imputation, k-Nearest Neighbors (k-NN) imputation, or regression imputation methods, depending on the nature and distribution of the missing data. The data cleaning process may also involve standardizing data formats across different network components and log sources, which may involve the development of custom parsers or the use of natural language processing techniques to extract structured information from semi-structured or unstructured log data. Additionally, the system may implement advanced deduplication algorithms to identify and merge redundant entries, potentially using fuzzy matching techniques to account for slight variations in log entries. In some scenarios, the data cleaning step may incorporate domain-specific rules and heuristics based on expert knowledge of network operations, allowing for the identification and correction of known error patterns or inconsistencies in network log data. The cleaning process may also include temporal alignment of data from different sources, ensuring that timestamps are standardized and accounting for potential time zone differences or clock synchronization issues across distributed network components.

The storage in structured data frame component 212 may be implemented using a diverse range of data structures and storage techniques, extending beyond the specific implementation shown in FIG. 2. Alternative approaches may include the use of sophisticated relational database management systems (RDBMS) with optimized schemas for network data, NoSQL databases for handling semi-structured data, and/or distributed storage systems for managing large-scale network logs. The structured data frame may be organized using various schemas optimized for specific types of queries or analysis, potentially employing techniques such as star schemas or snowflake schemas used in data warehousing. For example, the system may utilize a column-oriented storage approach, such as Apache Parquet or ORC (Optimized Row Columnar) format, for efficient aggregation operations on specific network metrics. In scenarios dealing with time-series data, the system may leverage specialized time-series databases like InfluxDB or TimescaleDB, which are optimized for handling time-stamped data and provide efficient querying capabilities for time-based analysis. The storage system may also incorporate advanced data partitioning strategies, such as range partitioning, list partitioning, or hash partitioning, to improve query performance and data manageability. Indexing techniques may be extensively used, potentially including bitmap indexes for low-cardinality fields (e.g., network function types), B-tree indexes for high-cardinality fields (e.g., unique identifiers), and geospatial indexes for location-based queries. In distributed storage scenarios, the system may employ data sharding techniques to distribute data across multiple nodes, potentially using consistent hashing algorithms to ensure even data distribution and efficient data retrieval. The storage layer may also implement advanced caching mechanisms, such as multi-level caching or predictive caching based on query patterns, to further enhance performance for frequently accessed data.

Pattern mining component 214 and the extracting summary and detail tables procedures may involve an array of data aggregation and summarization techniques, offering more possibilities than initially suggested in FIG. 2. The system may generate multi-dimensional summary tables that provide high-level overviews of network performance metrics, such as average pass rates, error frequencies, or latency measurements across different network functions, geographical regions, time periods, and/or device types. These summary tables may employ advanced statistical measures like moving averages, exponential smoothing, or more complex time series decomposition techniques to capture trends and seasonality in network performance data. Detailed tables may include highly granular information, potentially capturing individual network events, error messages, or performance measurements at specific time intervals, with the ability to drill down to millisecond-level precision if required. For example, a summary table may show daily average latency for each network function, broken down by geographical region and device type, while also including trend indicators and statistical confidence intervals. This summary may be complemented by interactive visualizations that allow users to explore the data at different levels of granularity. A corresponding detailed table may list every instance where latency exceeded a certain threshold, including precise timestamps, affected components, associated error codes, and contextual information such as network load at the time of the event or recent configuration changes. The system may also generate correlation tables that highlight relationships between different network metrics or events, potentially using techniques like Pearson correlation coefficients or more advanced machine learning-based association rule mining. Additionally, the table generation process may incorporate anomaly detection algorithms to automatically flag unusual patterns or deviations from historical norms, providing operators with quick insights into potential issues that warrant further investigation.

Embedding using sentence transformers 218 may be implemented using a wide array of natural language processing techniques beyond the specific implementation shown in FIG. 2. The embedding process may utilize various types of neural network architectures for text embedding, such as BERT (Bidirectional Encoder Representations from Transformers), GPT (Generative Pre-trained Transformer), or custom-trained models specifically tailored to network-related terminology. These embedding models may be pre-trained on large corpora of general text and then fine-tuned on domain-specific datasets comprising network logs, operator queries, and/or technical documentation related to 5G and future network technologies. In some scenarios, the system may employ multi-modal embedding techniques that combine text data with numerical network metrics to create more comprehensive representations. For instance, the embedding process may incorporate time series data of network performance metrics alongside textual descriptions, potentially using techniques like temporal convolutional networks or long short-term memory (LSTM) networks to capture temporal dependencies. The embedding system may also implement attention mechanisms to focus on the most relevant parts of the input when generating embeddings, which may be particularly useful for handling long and complex network-related queries or log entries. Additionally, the embedding process may incorporate hierarchical structures to capture relationships between different levels of network components, potentially using techniques like hierarchical attention networks. The system may also implement online learning mechanisms to continuously update and improve the embedding models based on new data and user interactions, ensuring that the embeddings remain relevant and accurate as network technologies and terminology evolve.

The calculation of similarity scores between user questions and cached questions 220 may be achieved through a diverse range of methods extending beyond the approach shown in FIG. 2. The system may employ techniques such as cosine similarity, Jaccard similarity, or more advanced semantic similarity measures like Word Mover's Distance (WMD) or Universal Sentence Encoder. In some implementations, the similarity calculation may take into account the hierarchical structure of network components, potentially giving more weight to matches in certain network functions or locations. This hierarchical weighting may be implemented using techniques like tree-based similarity measures or by incorporating domain-specific ontologies. The system may also use ensemble methods, combining multiple similarity metrics to produce a more robust similarity score. For example, it may use a weighted combination of lexical similarity (e.g., n-gram overlap), semantic similarity (based on embeddings), and structural similarity (considering the parse tree of the questions). The weighting scheme for these different similarity components may be dynamically adjusted based on the nature of the queries and/or historical performance data. In some scenarios, the system may implement contextual similarity measures that take into account the current network state or recent events when comparing queries. This may involve incorporating time-decay factors to give more weight to recent, relevant queries, or using reinforcement learning techniques to optimize the similarity scoring based on the usefulness of past query matches. The system may also employ fuzzy matching algorithms to handle slight variations in terminology or phrasing. Additionally, the similarity scoring system may incorporate user feedback and interaction data, potentially using collaborative filtering techniques to identify similar queries based on user behavior patterns.

Named Entity Recognition (NER) 222 for user questions may be implemented using a wide range of techniques beyond those explicitly shown in FIG. 2. These may include rule-based systems, statistical models, and/or deep learning approaches. Rule-based NER systems may utilize carefully crafted regular expressions and dictionaries specific to network operations, potentially covering entities such as protocol names, device types, performance metrics, and/or location identifiers. Statistical NER models may employ techniques like Conditional Random Fields (CRF) or Hidden Markov Models (HMM) trained on large corpora of annotated network-related text. Deep learning approaches may include bidirectional LSTMs with CRF layers, transformer-based models like BERT fine-tuned for NER tasks, or more advanced architectures like nested NER models to handle hierarchical entity structures common in network configurations. The NER component may be trained on domain-specific datasets to recognize entities particular to network operations, such as specific 5G network functions (e.g., AMF, SMF, UPF), performance KPIs, or vendor-specific terminology. In some scenarios, the NER system may incorporate active learning techniques, improving its accuracy over time based on user interactions and feedback. This may involve periodically retraining the model on newly labeled data or implementing online learning algorithms that can update the model in real-time. The NER system may also employ techniques for handling out-of-vocabulary words, such as character-level embeddings or subword tokenization, to better cope with novel entity names or variations in technical terminology. Additionally, the NER component may implement context-aware entity linking, connecting recognized entities to a knowledge base of network components and concepts, potentially using techniques like graph neural networks to leverage the relationships between different network entities.

The filtering based on similarity and Named Entity Recognition (NER) to return code 224 may involve a diverse range of techniques beyond those explicitly shown in FIG. 2. The system may use a weighted combination of similarity scores and recognized entities to rank and retrieve relevant code snippets. This weighting scheme may be dynamically adjusted based on the nature of the query and/or historical performance data. For example, in queries related to specific network functions, the system may give higher weight to NER matches for network component names, while for performance-related queries, it may prioritize similarity in numerical ranges or metric names. The system may employ fuzzy matching algorithms to handle slight variations in entity names or query phrasings. In some implementations, the filtering process may incorporate contextual information, such as the user's role, recent network events, or time of day, to prioritize certain types of code or responses. For instance, if a recent network upgrade was performed, the system may give higher priority to code snippets related to new features or potential upgrade-related issues. The filtering mechanism may also leverage advanced information retrieval techniques, such as query expansion or relevance feedback, to improve the accuracy of code retrieval. Query expansion may involve adding synonyms or related terms to the original query based on domain-specific ontologies or word embeddings. Relevance feedback may incorporate user interactions with previous results to refine future queries. The system may also implement a multi-stage filtering process, first using computationally efficient methods like TF-IDF (Term Frequency-Inverse Document Frequency) to narrow down the search space, followed by more sophisticated semantic matching on the reduced set of candidates. Additionally, the filtering process may employ machine learning models, such as learning-to-rank algorithms or neural information retrieval models, trained on historical query-code pairs to optimize the ranking of retrieved code snippets.

The process of generating a dataframe or chart based on the query 226 may encompass a wide array of data visualization and analysis techniques extending beyond simple bar charts or line graphs. The system may generate complex visualizations such as heatmaps, network topology diagrams, or interactive dashboards. For instance, when analyzing network traffic patterns, the system may produce a heatmap overlaid on a geographical map, showing traffic intensity across different regions and time periods. For visualizing the relationships between different network components, it may generate interactive force-directed graph visualizations, allowing users to explore the network topology dynamically. The system may employ advanced statistical analysis methods to identify trends, anomalies, or correlations in the data. This may include time series decomposition to separate seasonal patterns from long-term trends in network performance data, or principal component analysis to identify the most significant factors contributing to network issues. In some scenarios, the system may use machine learning techniques to suggest the most appropriate visualization type based on the nature of the data and the user's query. For example, it may automatically choose between a time series plot and a geographical map based on whether the query focuses on temporal or spatial patterns in network performance. The system may also generate interactive visualizations that allow users to drill down into specific data points, apply filters on-the-fly, or switch between different levels of data aggregation. For complex queries involving multiple dimensions of data, the system may create coordinated multiple views, where interactions in one chart automatically update related views. Additionally, the dataframe or chart generation process may incorporate predictive analytics, potentially using techniques like ARIMA (Autoregressive Integrated Moving Average) or Prophet to forecast future network performance based on historical trends.

The generation of Python code for the user question 228 may be extended to support multiple programming languages and paradigms beyond what is shown in FIG. 2. While the figure shows Python code generation, the system may additionally or alternatively generate SQL queries for database interactions, R scripts for statistical analysis, or domain-specific languages used in network management. The code generation process may leverage advanced natural language processing techniques, potentially using models like GPT (Generative Pre-trained Transformer) or CodeGPTX, which are specifically fine-tuned for code generation tasks. These models may be trained on large corpora of network-related code and documentation to ensure domain-specific accuracy. The generated code may range from simple data retrieval and filtering operations to complex analytical routines. For example, it may generate code to perform time series analysis using libraries like pandas and statsmodels, anomaly detection using algorithms like Isolation Forest or DBSCAN, or predictive modeling using machine learning frameworks like scikit-learn or TensorFlow. In some implementations, the code generation process may incorporate best practices for performance optimization and error handling. This may include generating code that uses vectorized operations for efficient data processing, implements proper exception handling and logging, and includes comments explaining the code's functionality. The system may also generate code that includes caching mechanisms or parallel processing for large-scale data analysis, potentially using libraries like joblib for parallelization or Redis for caching. For queries requiring real-time data processing, the system may generate code that interfaces with stream processing frameworks like Apache Kafka or Apache Flink. Additionally, the code generation component may implement version control integration, automatically creating Git commits or merge requests for the generated code, facilitating collaborative development and code review processes within the network operations team.

The code testing operation 234 may remove various types of potential security threats or unsafe operations beyond those explicitly mentioned in FIG. 2. This may include checking for and removing code that could lead to infinite loops, memory leaks, or excessive resource consumption. The testing process may employ static code analysis tools to identify potential vulnerabilities such as SQL injection risks, cross-site scripting (XSS) vulnerabilities, or unsanitized input handling. These static analysis tools may be customized with rules specific to network management operations, focusing on common pitfalls in network data processing and API interactions. In some scenarios, the code testing step may include runtime analysis in a sandboxed environment to detect potentially harmful behavior that may not be apparent from static analysis alone. This sandboxed execution may simulate various network conditions and edge cases to ensure the code behaves correctly under different scenarios. The system may also incorporate version control checks to ensure that generated code is compatible with the current network infrastructure and software versions. This may involve checking against a database of known compatible library versions and API endpoints. The code testing operation may also implement data privacy checks, ensuring that the generated code does not inadvertently expose sensitive network information or violate data protection regulations. This may include checks for hardcoded credentials, unencrypted data transmissions, or unauthorized access to restricted network zones. Additionally, the testing process may include performance profiling, identifying and optimizing code sections that may cause performance bottlenecks when dealing with large-scale network data. The system may also implement checks for code quality and maintainability, potentially using tools like linters or complexity analyzers to ensure the generated code adheres to best practices and coding standards adopted by the network operations team.

FIG. 3 illustrates an example detailed dashboard output 300 with a heat map representation of network function status. The dashboard 300 may be part of a graphical user interface for a cellular network health software tool, specifically designed for monitoring and/or analyzing 5G core network functions. The dashboard 300 may provide a comprehensive view of network health, allowing operators to quickly assess the status of various network functions across different locations and/or time periods. At the top of the dashboard 300, a title “5G Core Network: Gen AI Assistant” is displayed, which may indicate the purpose and/or scope of the tool. The use of “Gen AI” in the title may suggest the integration of generative artificial intelligence techniques in the analysis and/or presentation of network health data. This integration may allow for more sophisticated data processing, predictive analytics, and/or natural language interactions with the system. Below the title, the dashboard 300 includes several interactive elements that may allow users to customize their view of the network health data. These elements may include four dropdown buttons, each potentially serving a specific purpose in filtering and/or organizing the displayed information. The customization options may enable operators to tailor the dashboard to their specific preferences, potentially focusing on particular areas of concern or interest within the network.

The first dropdown button 302 is labeled “Select Network Function” and shows an option of “N6” selected. This dropdown may allow users to focus on specific network functions within the 5G core, such as N1, N2, N3, and/or so on. In some 5G network implementations, N6may refer to the interface associated with the User Plane Function (UPF). By providing this option, the dashboard may enable operators to isolate and/or analyze individual components of the network architecture. The ability to select specific network functions may be particularly useful in troubleshooting scenarios, where issues may be localized to certain components of the network. The second dropdown button 304 is labeled “Select Segmentation Order” and displays the option “Date->BEDC Region.” This feature may allow users to choose how the data is organized and/or presented, potentially enabling them to view trends over time or compare different geographical regions. The “BEDC Region” may refer to specific areas where Base Band Unit (BBU), Edge Data Center (EDC), or other network components are located. This segmentation option may be valuable for identifying patterns or issues that are specific to certain time periods or geographical areas, potentially helping operators to pinpoint the source of performance variations. The third dropdown button 306 is labeled “Select Time Window” and shows an “All” option. This dropdown may enable users to specify the time range for the displayed data, potentially allowing them to focus on recent events or examine long-term trends. The ability to adjust the time window may be particularly useful for both real-time monitoring and historical analysis, potentially enabling operators to identify both immediate issues and long-term patterns in network performance. The fourth dropdown button 308 is labeled “Select DNS” and also displays an “All” option. This may allow users to filter data based on specific Domain Name System servers or configurations within the network. DNS-specific filtering may be valuable for isolating issues related to name resolution or traffic routing within the network.

Below these dropdowns, two radio buttons 310 and 312 provide options for selecting the data source. Button 310 is labeled “Network Logs Summary,” while button 312 is labeled “Detailed Logs.” These options may allow users to choose between a high-level overview of network performance or a more granular view of individual log entries, depending on their specific needs and/or the level of detail required for their analysis. The ability to switch between summary and detailed views may be particularly useful for operators who need to balance quick assessments with in-depth investigations. The network logs summary may provide a quick overview of network health, potentially highlighting key performance indicators or notable events. In contrast, the detailed logs may offer a more comprehensive view, potentially including individual error messages, performance metrics, and/or other low-level data that may be useful for root cause analysis or detailed troubleshooting. The flexibility to switch between these views may enable operators to efficiently navigate between high-level monitoring and detailed problem-solving tasks.

The central feature of the dashboard 300 is a heat map 316, which provides a visual representation of network health across different dimensions, such as time and/or location. The heat map 316 may use color coding or shading to indicate the status or performance levels of network functions. This visualization technique may allow operators to quickly identify patterns, anomalies, or areas of concern within the network. The use of a heat map may be particularly effective for representing multi-dimensional data, as it can convey information about multiple variables simultaneously through color variations. Adjacent to the heat map 316, a vertical scale or chart is displayed, potentially serving as a legend for the heat map. This scale ranges from 70 at the bottom to 100 at the top, representing a pass rate or other performance metric. The scale uses different shadings or hatchings to distinguish between performance ranges, with distinct sections for 70-98, 98-99, and/or 99-100 (approximately). This granular breakdown at the higher end of the scale may allow for quick identification of minor variations in high-performing areas of the network. The decision to focus on the upper range of the scale (70-100) may reflect an emphasis on maintaining high performance standards, where even small deviations from optimal performance may be significant. The use of different shading or hatching for narrow ranges at the top of the scale (98-99 and 99-100) may help operators quickly identify areas of exceptional performance or slight degradations that might otherwise go unnoticed.

To the right of the heat map 316, the dashboard 300 includes a natural language query interface 314. In the example shown, the query “What is the pass rate for each location on 2024 Jul. 3?” is displayed. This feature may demonstrate the system's ability to process natural language questions, potentially making it easier for operators to interact with the tool and/or obtain specific information without needing to navigate complex query interfaces or understand underlying data structures. The natural language query capability may significantly enhance the usability of the system, potentially allowing operators with varying levels of technical expertise to extract meaningful insights from the network data. This feature may leverage advanced natural language processing techniques to interpret user queries, map them to relevant data sources, and/or generate appropriate responses. Below the query interface, a bar chart 318 is displayed, showing the pass rate for each location on the specified date (2024 Jul. 3). The chart has a vertical axis representing the pass rate from 0 to 100, and/or a horizontal axis listing approximately 15 cities from Atlanta to Washington DC. This visualization may allow for quick comparison of network performance across different geographical locations. The use of a bar chart for this purpose may be effective, as it allows for easy visual comparison of performance metrics across multiple categories (in this case, cities). The choice to display pass rates for multiple cities simultaneously may enable operators to identify location-specific issues or patterns, which could be valuable for targeted troubleshooting or resource allocation.

At the bottom of the dashboard 300, interactive elements for user feedback are included. A prompt asking “Was this response helpful?” is followed by two buttons: button 320 labeled “Not Helpful” and/or button 322 labeled “Helpful.” This feedback mechanism may allow the system to learn from user interactions and/or potentially improve its responses over time. The inclusion of a binary feedback option (helpful or not helpful) may provide a simple yet effective way for users to indicate the relevance and/or utility of the system's responses. This feedback data may be used to fine-tune the natural language processing models, improve the relevance of generated visualizations, and/or enhance the overall user experience. Additionally, an input element 324 is provided, prompting the user to “Write to the Chatbot . . . ” This feature may allow for follow-up questions or refinements to the initial query, potentially enabling a more conversational interaction with the AI assistant. The ability to engage in a dialogue with the system may be particularly valuable for complex queries that require multiple iterations or clarifications. A submit button is located on the right side of this input field, allowing users to send their additional queries or feedback. The placement of this button may provide a clear and intuitive way for users to interact with the system, potentially encouraging ongoing engagement and exploration of the network data.

In some examples, the number and/or identity of the fields manipulated through the drop-down menus 302, 304, 306, and/or 308 may vary significantly from what is shown in FIG. 3. The system may offer additional drop-down menus for filtering and/or customizing the displayed data. These may include options for selecting specific device types, network protocols, error types, and/or performance thresholds. The “Select Network Function” drop-down 302 may be expanded to include a hierarchical selection of network functions, potentially allowing users to drill down from high-level functions to specific sub-components. The “Select Segmentation Order” drop-down 304 may offer more complex ordering options, such as multi-level segmentation based on combinations of date, region, function type, and/or performance metrics. The “Select Time Window” drop-down 306 may provide more granular time selection options, potentially including custom date ranges, rolling time windows, and/or options to compare multiple time periods simultaneously. The “Select DNS” drop-down 308 may be extended to include other network services or components beyond DNS, such as load balancers, firewalls, and/or specific network slices in a 5G or 6G context. Additionally, the system may incorporate dynamic field generation, where the available drop-down options may change based on the current network state, user role, and/or recent network events.

The user interface for manipulating data and/or customizing views may extend beyond the drop-down menus shown in FIG. 3. The system may implement slider controls for adjusting numerical thresholds or date ranges, potentially allowing for more intuitive and/or precise selection of continuous variables. Tree-view selectors may be used for hierarchical data, enabling users to expand and/or collapse different levels of network components or geographical regions. The interface may incorporate drag-and-drop functionality, allowing users to construct complex queries by combining different data elements visually. Toggle switches may be used for binary options, such as including or excluding specific data sources. Multi-select checkboxes may allow users to choose multiple options simultaneously within a single category. The system may also implement type-ahead search fields with autocomplete functionality, enabling users to quickly find and select specific items from large datasets. Advanced users may be provided with a query builder interface, allowing them to construct complex logical expressions for data filtering. The interface may also include voice command functionality, potentially allowing users to modify data views or execute queries through spoken instructions. Additionally, the system may offer gesture-based controls for touchscreen devices, enabling users to zoom, pan, or filter data through intuitive touch gestures.

The heat map visualization 316 may be extended and/or modified in various ways to represent multi-dimensional data and/or alternative visualization techniques. The system may implement a 3D heat map, where the z-axis represents an additional variable such as time or a specific performance metric. This 3D representation may be interactive, allowing users to rotate, zoom, and/or slice the data cube to explore different perspectives. The heat map may also be enhanced with additional visual elements, such as overlaying icons or glyphs to represent specific events or thresholds within each cell. In some scenarios, the system may use a series of small multiples, displaying multiple heat maps side by side to compare different metrics or time periods simultaneously. The color scheme of the heat map may be customizable, potentially allowing users to choose from different color palettes optimized for various types of color vision deficiencies. The system may also offer alternative visualization techniques that serve a similar purpose to the heat map. These may include treemaps for hierarchical data representation, choropleth maps for geographical data, or sunburst diagrams for visualizing hierarchical relationships and performance metrics simultaneously. In some implementations, the system may incorporate audio feedback, potentially using different tones or volumes to represent data intensity, which may be particularly useful for accessibility purposes or for monitoring without constant visual attention.

The data sources used for analysis and visualization may extend beyond the options shown in FIG. 3, which include “Network Logs Summary” 310 and/or “Detailed Logs” 312. The system may incorporate real-time telemetry data from network devices, potentially including packet-level information for deep network analysis. It may also integrate data from external sources such as weather APIs to correlate network performance with environmental factors, and/or social media feeds to gauge user sentiment and/or detect service issues reported by customers. The system may pull data from network performance monitoring tools, security information and event management (SIEM) systems, and/or customer relationship management (CRM) platforms to provide a more comprehensive view of network health and its impact on user experience. In some scenarios, the system may also incorporate historical data archives for long-term trend analysis, potentially including data from previous network generations to track improvements or recurring issues across technology transitions. The data sources may also include predictive models and/or simulation results, allowing users to compare actual network performance against forecasted or idealized scenarios. Additionally, the system may allow for the integration of custom data sources defined by users, potentially including spreadsheets or databases maintained by different departments within the organization.

The pass rate chart 318 may be extended to visualize multiple variables and/or alternative visualization techniques. Instead of a simple bar chart, the system may implement a stacked bar chart to show the composition of pass rates across different network functions or error types for each location. A grouped bar chart may be used to compare pass rates across multiple time periods for each location. The system may also offer a heat map representation of the pass rate data, potentially using color intensity to represent pass rates across a grid of locations and time periods. In some scenarios, the pass rate information may be visualized as a bubble chart, where the size of each bubble represents the volume of traffic or number of tests performed, and the color represents the pass rate. The system may also provide options for visualizing pass rate trends over time, potentially using line charts with multiple series for different locations or network functions. For comparing pass rates across many dimensions simultaneously, the system may offer parallel coordinates plots or radar charts. Interactive elements may be incorporated, such as brushing and linking between different visualizations, allowing users to select subsets of data in one chart and see the corresponding data highlighted in others. Additionally, the system may provide options for statistical visualizations, such as box plots or violin plots, to show the distribution of pass rates across different categories.

The natural language query interface 314 and the corresponding chatbot functionality may support a wide range of queries and answers. Users may ask questions like “What was the average latency for video streaming services in the downtown area last weekend?” and the system may respond with a summary statistic and/or a time series graph showing latency variations. More complex queries such as “Identify the top 3 factors contributing to decreased network performance in rural areas over the past month” may result in a detailed analysis, potentially including a ranked list of factors with supporting evidence and visualizations. The chatbot may handle comparative queries, such as “How does the current network utilization compare to the same time last year?” and provide a response with year-over-year comparisons and trend analysis. Users may also ask predictive questions like “Based on current trends, when are we likely to reach 95% 5G coverage in the northeastern region?” and the system may respond with forecasts and confidence intervals. The chatbot may support diagnostic queries such as “What could be causing the spike in packet loss on the western edge of the network?” and provide a list of potential causes with probabilities and suggested troubleshooting steps. Additionally, the system may handle queries about network optimization, such as “Where should we prioritize infrastructure upgrades to maximize improvement in user experience?” and respond with data-driven recommendations and cost-benefit analyses.

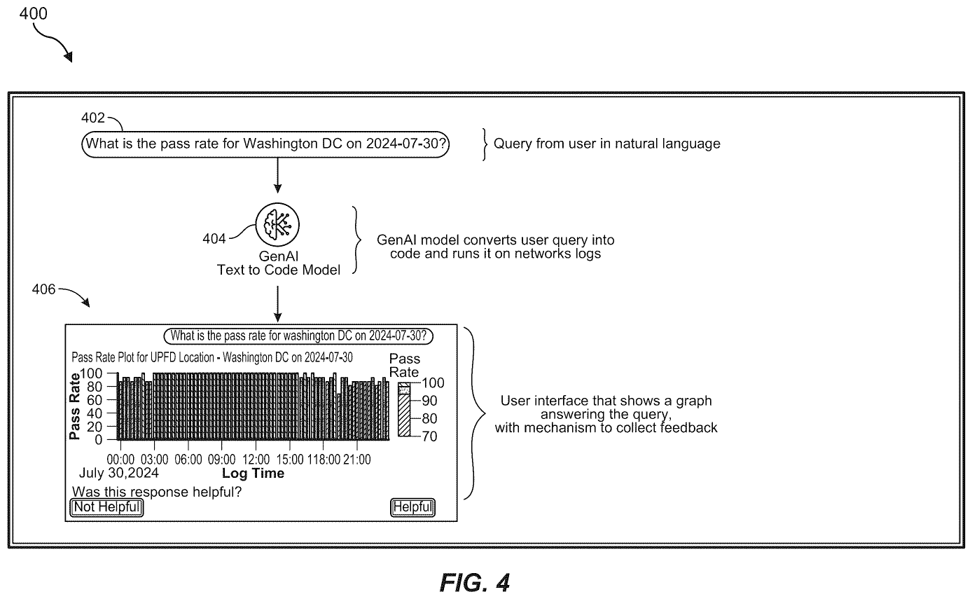

FIG. 4 illustrates an example simplified representation of the query processing and result visualization workflow in the cellular network health software tool. The figure shows three main components arranged vertically, representing the flow of information from user input to output visualization. At the top of the figure, a natural language query 402 is displayed. The query reads “What is the pass rate for Washington DC on 2024 Jul. 30?” This component is labeled with text in brackets stating “Query from user in natural language.” This representation may demonstrate the system's capability to accept and/or process queries in plain language, potentially making it more accessible to users with varying levels of technical expertise. The natural language input may allow for a wide range of query formulations, from simple status checks to more complex analytical questions about network performance. The system may be designed to handle ambiguities in natural language, potentially interpreting context and/or user intent to provide more relevant results. In some examples, the system may support multi-language queries, allowing users to interact with the tool in their preferred language, which may be particularly valuable for global network operations teams.

Below the query, an icon 404 labeled “GenAI text to code model” is shown. This icon is accompanied by bracketed text explaining “GenAI model converts user query into code and runs it on network logs.” This component may represent the processing engine of the system, where the natural language query is interpreted, translated into executable code, and/or run against the network log database. The use of a generative AI model for this task may allow for flexible and/or accurate interpretation of user queries, potentially handling a wide variety of question formulations and/or intents. The model may generate code in various programming languages and/or query formats, depending on the nature of the question and/or the underlying data storage system. In some scenarios, the GenAI model may adapt to user preferences over time, learning from past interactions to improve the relevance and/or efficiency of code generation. The system may also incorporate domain-specific knowledge about network architectures and/or protocols, potentially enhancing its ability to generate accurate and/or optimized queries for network performance analysis.

The pass rate chart 406 in FIG. 4 shows a time series plot of the pass rate for the UPFD (User Plane Function Data) in Washington, DC on Jul. 30, 2024. The x-axis represents the time of day, ranging from 00:00 to 21:00, extending to midnight. The y-axis represents the pass rate as a percentage. The plot may show variations in the pass rate throughout the day, potentially revealing patterns and/or anomalies in network performance. This visualization may provide network operators with a detailed view of how the UPFD's performance fluctuates over a 24-hour period in a specific location, allowing them to identify peak performance times, periods of degraded service, and/or any recurring patterns that may require attention. The granularity of the time axis may be adjustable, potentially allowing users to zoom in on specific time periods of interest. The system may also incorporate interactive elements in the chart, such as hover-over tooltips that display precise values and/or additional metadata for each data point. In some implementations, the chart may include overlay options to display additional context, such as network events, maintenance windows, or external factors that may impact performance.

In contrast to the pass rate chart in FIG. 3, which displayed pass rates for multiple cities on a single date, the chart in FIG. 4 focuses on a single location (Washington, DC) but shows the temporal variation of the pass rate throughout the day. This difference in visualization may highlight the system's flexibility in presenting data at different levels of granularity and/or along different dimensions. While FIG. 3's chart may be useful for comparing performance across geographical locations, FIG. 4's chart may be more suitable for analyzing performance fluctuations within a single location over time. This contrast may demonstrate the system's ability to provide both broad, multi-location overviews and/or detailed, time-based analyses of specific network components or locations. The system may enable users to seamlessly switch between these different views, potentially enabling them to drill down from a high-level geographical comparison to a detailed temporal analysis for any selected location. In some scenarios, the system may offer split-screen or overlay options, allowing users to compare multiple visualizations simultaneously, such as viewing the daily performance trend for a specific location alongside the multi-city comparison.

The system may support a wide variety of queries and/or corresponding plot types, showcasing its versatility in analyzing and/or visualizing network performance data. Users may ask questions such as “Compare 5G coverage between urban and rural areas over the past month,” which may result in a multi-line plot showing daily 5G coverage percentages for urban and/or rural areas, allowing for easy comparison of coverage trends. Another query might be “What is the correlation between network latency and user data consumption during peak hours?” This may generate a scatter plot with latency on one axis and data consumption on the other, potentially revealing relationships between these metrics. The system may handle complex queries like “Identify the top factors contributing to network outages in the past quarter,” producing a Pareto chart or treemap visualization that ranks and/or categorizes the primary causes of outages. For capacity planning purposes, a query such as “Forecast network bandwidth requirements for the next six months based on current growth trends” may result in a predictive line chart with confidence intervals, potentially incorporating seasonal patterns and/or external factors. The system may also support comparative analyses, such as “How does the current week's network performance compare to the same week last year?” This may generate a side-by-side or overlay comparison of key performance indicators. For troubleshooting purposes, a query like “Show the propagation of errors across network nodes during yesterday's outage” may produce an interactive network graph visualization, potentially animating the spread of errors over time. The system may handle queries about specific network protocols, such as “Analyze the efficiency of handovers between 4G and 5G networks in high-traffic areas,” potentially resulting in a heat map overlaid on a geographical map to show handover success rates. Additionally, the system may support queries about user experience, such as “What is the relationship between signal strength and video streaming quality for mobile users?” This may generate a multi-axis chart combining signal strength, streaming quality metrics, and/or user location data.

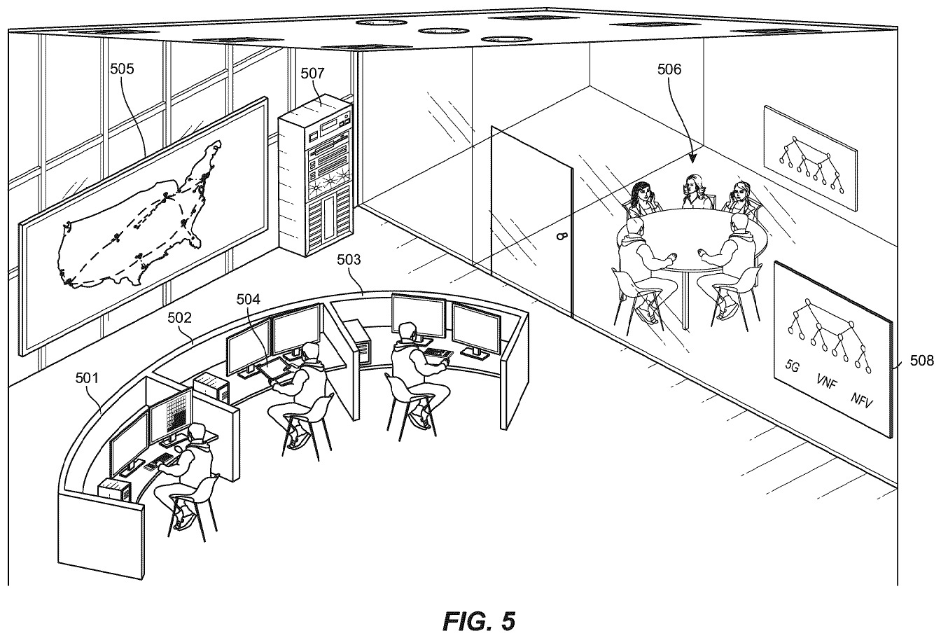

FIG. 5 illustrates an example comprehensive view of a mobile operator's Network Operations Center (NOC), depicting the real-world application of the cellular network health software tool. The figure shows a large, open-plan office space viewed from a slight overhead angle, representing a typical NOC environment where network monitoring and maintenance activities are conducted. This layout may facilitate efficient communication and collaboration among team members, potentially enhancing the overall effectiveness of network management operations. The overhead view may allow for a clear understanding of the spatial relationships between different elements within the NOC, which may be valuable for optimizing workflow and/or resource allocation. In some examples, the room layout may be customizable, allowing for reconfiguration based on changing operational needs and/or the introduction of new monitoring technologies.

In the foreground of the NOC, three workstations 501, 502, and 503 are arranged in a slight arc. This multi-monitor setup allows operators to simultaneously view different aspects of network performance and/or run multiple applications concurrently. The arrangement of these workstations may be designed to optimize workflow and/or enhance situational awareness within the NOC. At each workstation, an operator is shown sitting in an office chair, dressed in business casual attire, which suggests a professional yet comfortable working environment. The operators' postures indicate engagement with their work, highlighting the focus and attention required in monitoring complex network systems. The arc arrangement of the workstations may promote easy communication between operators, potentially facilitating quick information sharing and/or collaborative problem-solving. In some scenarios, the workstation setup may be ergonomically designed to reduce operator fatigue during long monitoring sessions, which may be particularly important during network emergencies or maintenance windows that require extended periods of focused attention.

The monitor at workstation 501 displays a simplified version of the heat map from FIG. 3, represented as an 8×8 grid of cells. Some cells are shaded darker than others using crosshatching or stippling, indicating varying levels of network performance across different regions or network components. This visualization allows operators to quickly identify areas of concern or exceptional performance at a glance. At workstation 502, an operator is shown holding a tablet device 504, approximately the size of an iPad, in their left hand while interacting with the screen using their right hand. The tablet's screen can display a simplified version of the network health tool interface. This mobile interface demonstrates the tool's flexibility and accessibility, allowing operators to monitor and manage network health while moving around the NOC or even when away from their primary workstations. The integration of mobile devices into the NOC environment may significantly enhance operational flexibility, potentially allowing for rapid response to network issues regardless of the operator's physical location within the facility.

Spanning the width of the back wall, a large wall-mounted display 505, dominates the room. This display shows an outline map of the United States with network coverage indicators represented by different patterns of dotted or dashed lines, indicating varying levels of coverage across different regions. Small icons represent major cities like New York, Los Angeles, Chicago, and Houston. This large-scale visualization provides a comprehensive overview of the network's status across the entire country, allowing operators to quickly identify regional trends, coverage gaps, or widespread issues. The size and prominence of this display facilitate group discussions and/or collaborative problem-solving among the NOC team. The use of different patterns for coverage indicators may allow for the representation of multiple network parameters simultaneously, such as signal strength, data speeds, and/or reliability metrics. In some implementations, this large display may be interactive, allowing operators to zoom into specific regions or access detailed information about particular network elements by touching or gesturing at different areas of the map.

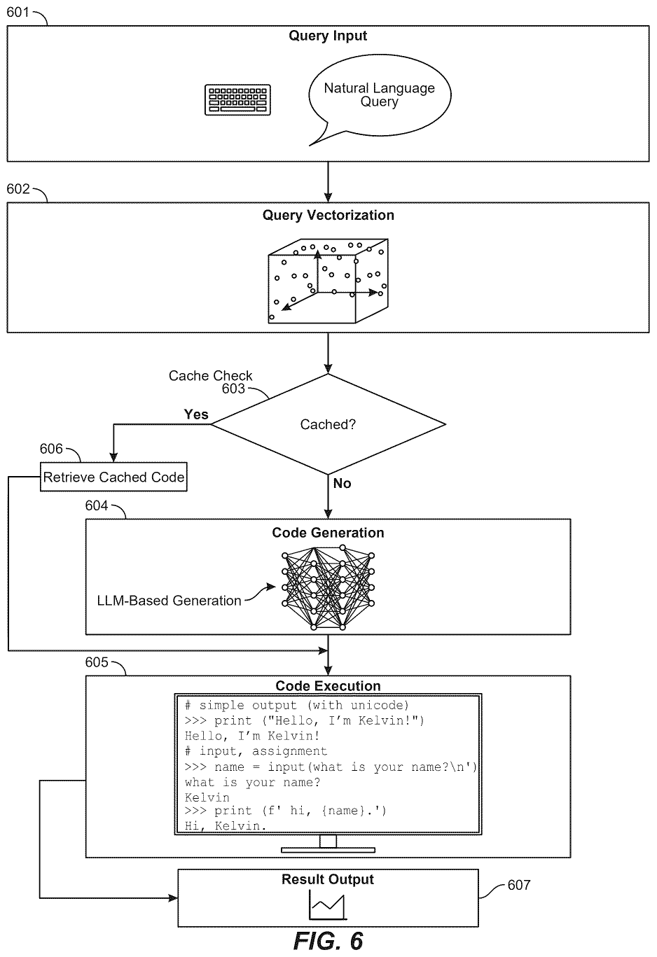

FIG. 6 illustrates an example detailed process flow of query handling and code generation within the cellular network health software tool. The figure presents a vertical flow diagram that spans the entire page, depicting the journey of a natural language query from input to result output. This comprehensive visualization may provide insights into the internal workings of the system and/or elucidate the various stages involved in processing user queries. In some implementations, this process flow may be modular, allowing for the insertion of additional processing steps or the modification of existing ones to accommodate new network technologies or query types. The overall structure of the diagram may also serve as a high-level guide for system administrators or developers who may need to troubleshoot or optimize specific parts of the query handling process.

At the top of the diagram, a Query Input 601 contains a simplified keyboard icon and a text bubble with “Natural Language Query” written inside it. This representation may symbolize the user interface where network operators and/or other authorized personnel may input their queries in natural language. The use of natural language input may significantly enhance the accessibility of the tool, potentially allowing users with varying levels of technical expertise to interact with the system effectively. In some implementations, the query input mechanism may support multiple input modalities, such as voice recognition and/or gesture-based inputs, which may further improve the tool's usability in different operational contexts. The system may also incorporate context-aware input processing, potentially taking into account factors such as the user's role, recent network events, or historical query patterns to enhance the interpretation of the input. Additionally, the query input interface may include features like autocomplete suggestions or query templates, which may help guide users towards more effective query formulations. In some scenarios, the system may allow for the inclusion of attachments or references to external data sources as part of the query input, potentially enabling more complex and data-driven inquiries about network health.

An arrow points down from the Query Input 601 to the next box labeled “Query Vectorization” 602. Inside this box, a simplified representation of a vector space is depicted using three intersecting lines to suggest a 3D coordinate system, with small dots scattered in this space to represent vectorized queries. This vectorization process may involve transforming the natural language query into a high-dimensional numerical representation, which may enable more efficient processing and/or comparison of queries. The vector space representation may capture semantic relationships between different queries, potentially allowing the system to identify similarities between new queries and previously processed ones. In some scenarios, the vectorization technique may be adaptable, potentially evolving over time to better represent the specific vocabulary and/or query patterns commonly used within the organization's network operations. The system may employ advanced natural language processing models, such as BERT or GPT, to generate these vector representations, potentially capturing nuanced semantic meanings and contextual information. The vectorization process may also incorporate domain-specific knowledge about network operations, potentially using custom-trained embeddings that are tailored to the unique language and concepts used in cellular network management. In some implementations, the vector space may be visualized or explored by system administrators, potentially providing insights into common query clusters or identifying gaps in the system's knowledge base.

From the Query Vectorization box 602, an arrow points down to a diamond-shaped decision box labeled “Cache Check” 603. Inside this diamond, the text “Cached?” indicates the decision point. This cache check mechanism may serve as a helpful optimization step, potentially reducing response times for frequently asked queries and/or minimizing computational resources required for query processing. The caching system may employ sophisticated strategies to balance between providing rapid responses and ensuring the freshness of the returned information. In some implementations, the cache may be hierarchical, with different levels of caching for queries with varying frequencies and/or complexity. The cache may also incorporate intelligent expiration policies, potentially using machine learning algorithms to predict when cached responses are likely to become outdated based on historical data and network change patterns. Additionally, the cache may support partial matches, allowing for the retrieval and adaptation of cached responses that are similar but not identical to the current query. This partial matching capability may significantly extend the utility of the cache, potentially providing speed benefits even for queries that have not been asked in exactly the same way before. The cache system may also include mechanisms for preemptive caching, anticipating and preparing responses for likely future queries based on current network states and historical query patterns.

From the left point of the Cache Check diamond 603, an arrow labeled “Yes” curves down and to the left, leading to a box labeled “Retrieve Cached Code” 606. This path represents the scenario where a matching or similar query has been previously processed and cached. The retrieval of cached code may significantly expedite the query response process, potentially providing near-instantaneous results for common or recurring queries. The cached code retrieval mechanism may incorporate versioning and/or timestamp information to ensure that the retrieved code is still relevant and applicable to the current network state. In some examples, the system may perform a quick validation check on the retrieved cached code to verify its compatibility with the current network configuration before execution. The caching system may employ sophisticated data structures, such as bloom filters or locality-sensitive hashing, to enable rapid lookups and similarity matching. Additionally, the cache may be distributed across multiple nodes in a network, potentially allowing for faster retrieval times and increased resilience against system failures. The system may also implement a cache warming strategy, periodically executing commonly used queries to keep the cache up-to-date and responsive.

From the right point of the Cache Check diamond 603, an arrow labeled “No” curves down and to the right, leading to the “Code Generation” box 604. Inside this box, a simplified representation of a neural network is shown using circles connected by lines, labeled “LLM-based Generation”. This visualization represents the process of generating new code using a Large Language Model (LLM) when a cached response is not available. The LLM-based code generation may provide the system with the flexibility to handle novel or complex queries that have not been encountered before. The neural network representation may suggest the sophisticated nature of the code generation process, potentially involving multiple layers of processing to interpret the query and generate appropriate code. In some implementations, the LLM may be fine-tuned specifically for network-related queries and/or periodically updated to incorporate new network technologies and terminologies. The code generation process may involve several sub-steps, such as query understanding, intent classification, and code synthesis. The system may employ techniques like few-shot learning or prompt engineering to improve the relevance and accuracy of the generated code. Additionally, the code generation module may incorporate safety checks and best practices to ensure that the generated code adheres to security protocols and performance standards.

Arrows from both the “Retrieve Cached Code” box 606 and the “Code Generation” box 604 converge into the “Code Execution” box 605 at the bottom of the diagram. Inside the Code Execution box, a simplified representation of a computer screen with lines of code suggests the execution of the generated or retrieved code. This unified execution pathway underscores the system's ability to handle both cached and newly generated responses. The code execution environment may be sandboxed for security purposes, potentially preventing any unintended interactions with critical network systems. In some implementations, the execution may be distributed across multiple processing units or cloud resources to handle complex queries or high concurrent load. The system may also implement real-time monitoring of code execution, potentially identifying and addressing any performance bottlenecks or errors during runtime. Additionally, the code execution module may include logging and auditing features, allowing for post-execution analysis and continuous improvement of the code generation and caching processes.

At the very bottom of the diagram, an arrow points down from the Code Execution box 605 to a final box labeled “Result Output” 607. Inside this box, a simplified chart or graph icon represents the output. This visualization emphasizes the system's ability to transform complex queries into comprehensible, actionable insights. The result output may take various forms depending on the nature of the query and the preferences of the user. These may include interactive dashboards, detailed reports, or alerts for critical issues. In some scenarios, the system may provide multiple output formats for the same query result, catering to different user roles or use cases. The output generation process may involve data visualization techniques, natural language generation for explanatory text, and potentially, recommendations for follow-up actions based on the query results. Additionally, the system may offer features for result sharing and collaboration, allowing multiple stakeholders to view and interact with the query outputs.

In some examples, the Query Input 601 may incorporate contextual awareness, potentially taking into account the user's role, recent network events, or historical query patterns to enhance the interpretation of the input. The query vectorization step 602 may employ domain-specific embeddings that capture the nuances of network-related terminology and concepts. The cache check mechanism 603 may utilize predictive algorithms to anticipate and preemptively cache likely future queries based on current network states and trends. The code generation process 604 may leverage few-shot learning techniques to adapt to new types of queries or network scenarios with minimal additional training. The code execution environment 605 may employ distributed computing resources to handle complex queries or high concurrent load efficiently. The result output stage 607 may incorporate adaptive visualization techniques, automatically selecting the most appropriate graphical representation based on the nature of the data and/or the user's preferences.

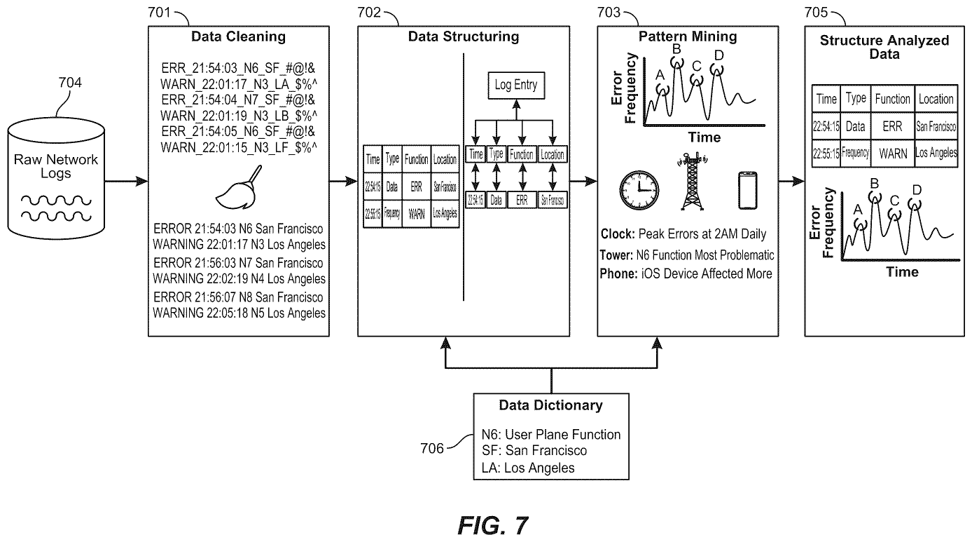

FIG. 7 illustrates an example detailed representation of the pre-processing layer in the cellular network health software tool, depicting the transformation of raw network log data into structured and analyzed information. The figure presents a horizontal flow diagram that spans the entire width of the page, showcasing three initial main sections arranged from left to right: Data Cleaning 701, Data Structuring 702, and Pattern Mining 703. This comprehensive visualization may elucidate the example steps involved in preparing network log data for efficient analysis and/or querying. The horizontal layout may emphasize the sequential nature of the pre-processing steps, potentially highlighting the logical progression from raw, unstructured data to refined, actionable insights. In some implementations, this pre-processing flow may be adaptable, allowing for the insertion of additional processing steps and/or the modification of existing ones to accommodate new data formats, network technologies, and/or analysis requirements. The overall structure of the diagram may also serve as a high-level guide for data engineers and/or system administrators who may desire to optimize and/or troubleshoot specific parts of the pre-processing pipeline. Additionally, the clear delineation of these pre-processing stages may facilitate modular development and/or maintenance of the system, potentially allowing for independent optimization and/or upgrading of each stage without disrupting the entire pipeline. The pre-processing layer may also incorporate feedback loops between stages, allowing for iterative refinement of the data cleaning, structuring, and/or mining processes based on insights gained from downstream analysis or user feedback.

On the far left of the diagram, a cylindrical shape labeled “Raw Network Logs” 704 represents the input data source. This cylinder contains wavy lines to suggest unstructured data. The raw network logs may encompass a wide variety of data types and/or formats, potentially including system logs, error messages, performance metrics, and/or user interaction data from various network components. The unstructured nature of these logs may pose significant challenges for direct analysis, indicating the subsequent pre-processing steps. In some scenarios, the raw log data may be streamed in real-time from multiple network sources, triggering the pre-processing layer to handle continuous data ingestion and/or processing. The system may employ advanced data ingestion techniques, such as log aggregation and/or distributed log collection, to efficiently gather and/or centralize logs from diverse network elements. Additionally, the raw log representation may include metadata about the log sources, timestamps, and/or initial categorization, which may aid in subsequent processing steps. The cylindrical shape of the raw log representation may suggest the volume and/or continuity of the data flow, emphasizing the ongoing nature of network log generation and/or the need for a robust, scalable pre-processing pipeline. In some implementations, the system may employ data sampling techniques to manage high-volume log streams, potentially using adaptive sampling rates based on network conditions and/or analysis priorities.

An arrow leads from the Raw Network Logs 704 to Data Cleaning 701. This box illustrates the transformation of messy log data into standardized, clean entries. At the top of the box, a series of jumbled text lines represent the messy log data, including a mix of numbers, letters, and/or symbols. Examples such as “ERR_21: 54:03_N6_SF_ #@! &” and/or “WARN_22: 01:17_N3_LA_$%” showcase the cryptic and/or inconsistent nature of raw log entries. In the middle of the box, a simple icon of a broom or brush symbolizes the cleaning process. At the bottom of the box, neat, aligned text lines represent the cleaned data, with examples like “ERROR 21:54:03 N6 San Francisco” and/or “WARNING 22:01:17 N3 Los Angeles”. This visual representation underscores the data cleaning process's role in standardizing log formats, resolving inconsistencies, and/or preparing the data for subsequent analysis. The data cleaning step may employ various techniques such as regular expression parsing, natural language processing for error message standardization, and/or lookup tables for expanding abbreviations and/or codes. In some implementations, the cleaning process may also involve data normalization, ensuring that numerical values are scaled appropriately and/or that categorical data is consistently represented. The system may utilize machine learning models trained on historical log data to identify and/or correct anomalies and/or inconsistencies that may not be captured by rule-based cleaning methods. Additionally, the data cleaning stage may incorporate domain-specific knowledge about network protocols and/or components to interpret and/or standardize log entries accurately.

From Data Cleaning 701, another thick arrow leads to the next box labeled “Data Structuring” 702. This box illustrates the organization of cleaned data into structured formats. On the left side of the box, a table-like structure with rows and/or columns is shown, with column labels such as “Time”, “Type”, “Function”, and/or “Location”. This tabular representation may suggest a relational database or structured data frame format. On the right side of the box, a tree-like structure represents a hierarchical data format, with a root node labeled “Log Entry” and/or child nodes for various log attributes. The data structuring process may involve techniques such as schema design, data normalization, and/or the creation of indexes for efficient querying. In some implementations, the system may employ adaptive schema techniques that can evolve based on changing log patterns and/or analysis requirements. The structured data formats may support both SQL and/or NoSQL query paradigms, potentially allowing for flexible and/or efficient data retrieval based on different analysis needs. Additionally, the data structuring step may incorporate metadata management, versioning, and/or lineage tracking to maintain data provenance and/or facilitate auditing of the pre-processing pipeline.

An arrow then leads to the box labeled “Pattern Mining” 703. This box illustrates the extraction of meaningful patterns and/or trends from the structured data. A simplified line graph with peaks and/or troughs represents temporal patterns in the data, such as error frequency over time. Circular markers overlaid on the graph highlight specific points or patterns, labeled with letters. Below the graph, simple icons of a clock, a network tower, and a smartphone are shown, each accompanied by a brief pattern description. These descriptions, such as “Peak errors at 2 AM daily”, “N6 function most problematic”, and/or “iOS devices affected more”, exemplify the types of insights that may be extracted through pattern mining. The pattern mining process may employ various techniques such as time series analysis, clustering algorithms, and/or association rule mining to identify recurring patterns, anomalies, and/or correlations in the network log data. In some implementations, the system may utilize advanced machine learning models, such as deep learning networks or probabilistic graphical models, to uncover complex, multi-dimensional patterns that may not be apparent through traditional statistical methods. The pattern mining step may also incorporate domain-specific heuristics and/or expert knowledge to guide the discovery of operationally relevant patterns and/or to filter out noise or spurious correlations.

On the far right of the diagram, a box labeled “Structured and Analyzed Data” 705 represents the output of the pre-processing layer. This box contains a combination of the table structure from the Data Structuring step and/or the graph from the Pattern Mining step, suggesting a rich, analyzed dataset. The structured and/or analyzed data may serve as the foundation for subsequent querying, visualization, and/or advanced analytics within the network health monitoring system. In some scenarios, this output may be stored in a high-performance data warehouse or distributed storage system, potentially enabling rapid access and/or analysis by downstream components of the cellular network health software tool.

Below the main flow, a small box labeled “Data Dictionary” 706 is shown, with thin arrows pointing to both the Data Structuring 702 and/or Pattern Mining 703 boxes. The Data Dictionary may contain definitions and/or explanations for various terms, acronyms, and/or concepts used in the network logs and/or analysis process. For example, it may define “N6” as “User Plane Function” and/or provide expansions for location abbreviations like “SF” for San Francisco and/or “LA” for Los Angeles. This Data Dictionary may play a role in maintaining consistency and/or clarity throughout the pre-processing pipeline, potentially aiding in data interpretation, standardization, and/or pattern recognition. In some implementations, the Data Dictionary may be dynamically updated based on new log patterns, network technologies, or user feedback, ensuring that it remains a comprehensive and/or up-to-date reference for the evolving cellular network ecosystem.

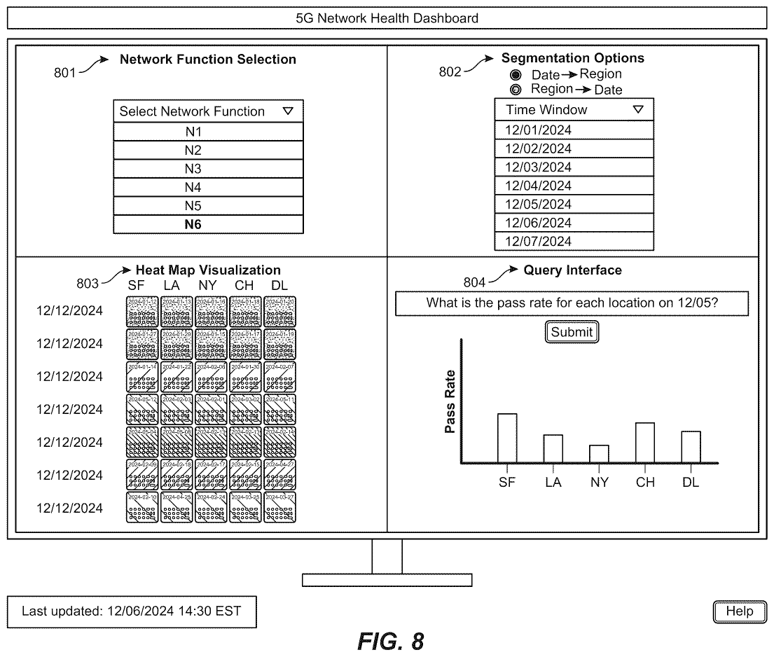

FIG. 8 illustrates an example detailed representation of the graphical user interface for the cellular network health software tool. The figure shows a rectangular frame representing a computer screen or large display, occupying most of the page. At the top of the frame, a header bar displays “5G Network Health Dashboard,” providing immediate context for the interface's purpose. The main area below the header is divided into four quadrants, each serving a distinct purpose in the interface. The top-left quadrant 801, labeled “Network Function Selection,” contains a dropdown menu with the label “Select Network Function:”. This dropdown is shown expanded, revealing options including “N1”, “N2”, “N3”, “N4”, “N5”, and “N6”, with “N6” highlighted as the selected option. This network function selection feature may allow users to focus their analysis on specific components of the 5G network architecture. The dropdown design may provide a compact yet accessible method for switching between different network functions, potentially enabling rapid comparisons across various aspects of the network. In some scenarios, this dropdown may be dynamically populated based on the current network configuration and/or user permissions, ensuring that only relevant and accessible options are presented. The system may also incorporate tooltips or brief descriptions for each network function, potentially aiding users who may be less familiar with specific 5G network components.

The top-right quadrant 802, labeled “Segmentation Options,” presents users with choices for how to view and organize the network health data. Two radio buttons are shown, labeled “Date→Region” and “Region→Date,” with “Date→Region” selected. This segmentation option may allow users to prioritize their view of the data, either by focusing primarily on temporal trends across regions or by examining regional variations over time. Below these radio buttons, a dropdown menu labeled “Time Window:” is displayed. This time window selection may enable users to adjust the scope of their analysis, potentially ranging from near real-time views to historical trend analysis. The combination of segmentation options and time window selection may provide users with flexible ways to slice and dice the network health data, potentially revealing patterns or issues that might not be apparent in a fixed view. In some implementations, the interface may allow for custom time window definitions or the ability to compare multiple time windows simultaneously.

The bottom-left quadrant 803, labeled “Heat Map Visualization,” displays a simplified version of the heat map introduced in FIG. 3, using a 5×7 grid. The rows are labeled with dates (e.g., “12/01”, “12/02”, etc.), while the columns are labeled with regions (e.g., “SF”, “LA”, “NY”, “CH”, “DL”). Different densities of crosshatching represent varying levels of network health, with denser patterns indicating more issues. This heat map visualization may provide users with a quick, intuitive overview of network health across both time and space. In some scenarios, this heat map may be interactive, allowing users to hover over or click on specific cells to reveal more detailed information about network health in that particular time-location combination. The system may also incorporate features like zooming or panning within the heat map, potentially enabling users to focus on specific areas of interest or to expand the view to encompass larger time frames or additional regions.

The bottom-right quadrant 804, labeled “Query Interface,” showcases the natural language query capabilities of the system. At the top of this quadrant, a text input field spans the width, containing the example query: “What is the pass rate for each location on 12/05?”. Below this field, a “Submit” button is shown, and under that, a simple bar chart displays pass rates for different locations (using “SF”, “LA”, “NY”, “CH”, “DL” as x-axis labels). This query interface may demonstrate the system's ability to interpret natural language questions and generate relevant visualizations in response. The inclusion of a pre-filled example query may guide users in formulating their own questions, potentially showcasing the types of insights the system may provide. In some implementations, the query interface may incorporate autocomplete or suggestion features, potentially helping users construct more effective queries. The system may also maintain a history of recent queries, allowing users to quickly revisit or modify previous analyses.

At the bottom of the frame, a status bar provides additional information and functionality. On the left side, the text “Last updated: Dec. 6, 2024 14:30 EST” is displayed, potentially informing users about the recency of the data being presented. This timestamp may be helpful for users making time-sensitive decisions based on the network health information. On the right side of the status bar, a small circle labeled “Help” is shown. This help feature may provide users with access to documentation, tutorials, or context-sensitive assistance related to the various components of the interface. In some scenarios, the help system may be intelligent, potentially offering suggestions based on the user's current activities or common queries related to the displayed network function or region.

In some examples, the graphical user interface may incorporate additional features to enhance usability and/or insights. These may include customizable dashboard layouts, allowing users to prioritize certain visualizations or add new data widgets. The interface may also support collaborative features, potentially enabling multiple users to share views, annotations, or analysis results in real-time. Advanced filtering options may be integrated throughout the interface, allowing users to focus on specific network parameters, device types, or performance thresholds. The system may also incorporate predictive elements, potentially highlighting areas of the heat map or suggesting queries based on emerging patterns or anomalies detected by underlying machine learning models.

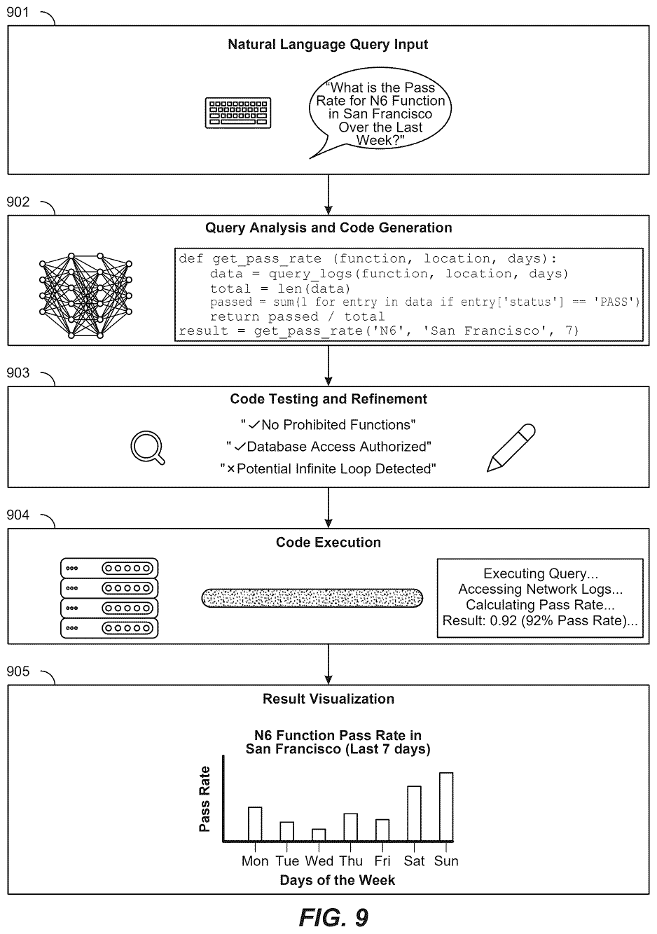

FIG. 9 illustrates an example detailed process flow for query handling, code generation, and result visualization within the cellular network health software tool. The figure presents a vertical flow diagram, progressing from top to bottom, with five main components labeled 901 through 905. Each component is represented by a large text box containing graphical illustrations that depict various stages of the query processing and analysis pipeline.

At the top of the diagram, component 901 is labeled “Natural Language Query Input”. This section showcases the user interface for query submission, featuring a graphical representation of a keyboard and a dialog box. The dialog box contains an example query: “What is the pass rate for N6 function in San Francisco over the last week?”. This representation may emphasize the system's capability to accept and process natural language inputs, potentially making the tool more accessible to users with varying levels of technical expertise. The specificity of the example query may also provide insights into the types of questions the system is designed to handle, potentially guiding users in formulating their own queries.

Component 902, labeled “Query Analysis and Code Generation”, illustrates the system's ability to translate natural language queries into executable code. This section displays a code snippet written in Python, demonstrating how the system may generate structured, functional code based on the user's query. The code defines a function get_pass_rate that takes three parameters: function, location, and days. This function queries log data, calculates the total number of entries, and determines the pass rate by counting entries with a ‘PASS’ status. The result is then calculated by calling this function with the specific parameters from the user's query: ‘N6’ for the function, ‘San Francisco’ for the location, and 7 for the number of days. The inclusion of this code snippet may provide transparency into the system's operation, potentially allowing more technically inclined users to understand and verify the logic behind the query processing.

Component 903, labeled “Code Testing and Refinement”, illustrates the system's code validation and optimization processes. This section displays three status messages: “No prohibited functions”, “Database access authorized”, and “Potential infinite loop detected”. The first two messages are accompanied by checkmarks, indicating successful validation, while the third message is marked with an X, indicating a potential issue for user attention. These status messages may demonstrate the system's ability to perform automated code review and security checks, potentially ensuring that the generated code adheres to safety and performance standards. The detection of a potential infinite loop may showcase the system's capability to identify and mitigate potential runtime issues before code execution.

Component 904, labeled “Code Execution”, represents the stage where the validated and refined code is run against the network log data. This section displays simplified server icons on the left, symbolizing the computing infrastructure used for code execution. On the right, a text box shows the execution progress and results: “Executing Query . . . ”, “Accessing Network Logs . . . ”, “Calculating Pass Rate . . . ”, and “Result: 0.92(92 % Pass Rate)”. This step-by-step output may provide users with real-time feedback on the query execution process, potentially increasing transparency and user confidence in the results. The clear presentation of the final result (92% Pass Rate) may allow for quick interpretation of the query outcome.

The final component, 905, labeled “Result Visualization”, showcases how the system translates numerical results into a graphical representation. This section displays a bar graph with “Pass Rate” on the vertical Y-axis and days of the week on the horizontal X-axis. The graph is labeled “N6 Function Pass Rate in San Francisco (Last 7 Days)”. This visualization may provide users with an intuitive and quickly comprehensible representation of the query results, potentially allowing for easy identification of trends or anomalies in network performance over time.

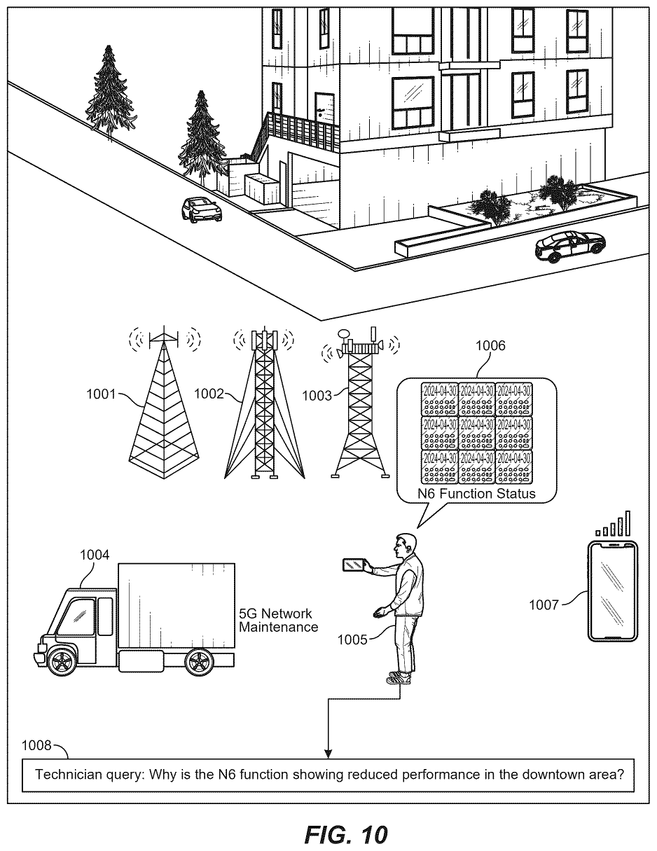

FIG. 10 illustrates an example real-world scenario of 5G network troubleshooting, showcasing the practical application of the cellular network health software tool in an urban environment. The figure presents a cityscape view, representing the diverse and challenging environments in which 5G networks operate. In the middle ground, three cell towers 1001, 1002, and 1003 are evenly spaced across the width of the frame, each depicted with a typical triangular antenna array. These towers may represent different types of 5G cells, such as macrocells, microcells, and/or small cells, each serving specific coverage and capacity needs within the urban environment. The spacing and positioning of these towers may indicate potential areas of overlapping coverage and/or handover zones, which may be specific points of interest for network performance optimization. In the foreground, a mobile network operator's van 1004 labeled “5G Network Maintenance” symbolizes the mobile nature of network troubleshooting activities. Adjacent to the van, a technician FIG. 1005 holds a tablet device, illustrating the modern, technology-driven approach to network maintenance. This tablet may serve as the technician's interface to the cellular network health software tool, potentially providing real-time access to network performance data, diagnostic tools, and/or the natural language query system.

Above the technician's head, a thought bubble 1006 contains a simplified 3×3 grid heat map labeled “N6 Function Status,” representing the technician's analysis of the current network state, focusing on the N6 function (User Plane Function) performance. On the right side of the frame, a 5G-enabled smartphone 1007 is depicted with a signal strength indicator. Dashed lines between the smartphone and the nearest cell tower represent the wireless signal, symbolizing the complex nature of 5G signal propagation in urban environments. At the bottom of the frame, a text box 1008 contains the technician's query: “Why is the N6 function showing reduced performance in the downtown area?” This natural language query may demonstrate the system's ability to handle complex, context-specific questions about network performance. An arrow pointing from the technician FIG. 1005 to the text box 1008 visually connects the technician to the query, emphasizing the interactive nature of the troubleshooting process. The overall composition of FIG. 10 provides a comprehensive view of how the cellular network health software tool integrates into real-world 5G network maintenance and optimization activities, illustrating the interplay between physical infrastructure, mobile devices, and human operators. This real-world context may showcase how the system may enable more efficient, proactive, and effective network management in diverse urban environments, potentially highlighting its value in supporting proactive network maintenance and ensuring high-quality 5G service for end-users.

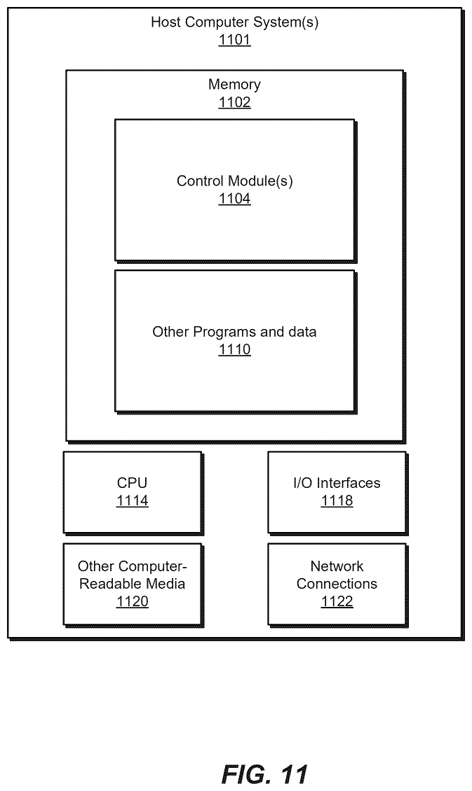

FIG. 11 shows a system diagram that describes an example implementation of a computing system(s) for implementing embodiments described herein. The functionality described herein may be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, enabling higher deployment agility and flexibility. However, FIG. 11 illustrates an example of underlying hardware on which such software and functionality may be hosted and/or implemented.

In particular, shown is example host computer system(s) 1101. For example, such computer system(s) 1101 may execute a scripting application, or other software application, as further discussed above, and/or to perform one or more of the other methods described herein. In some embodiments, one or more special-purpose computing systems may be used to implement the functionality described herein. Accordingly, various embodiments described herein may be implemented in software, hardware, firmware, or in some combination thereof. Host computer system(s) 1101 may include memory 1102, one or more central processing units (CPUs) 1114, I/O interfaces 1118, other computer-readable media 1120, and network connections 1122.

Memory 1102 may include one or more various types of non-volatile and/or volatile storage technologies. Examples of memory 1102 may include, but are not limited to, flash memory, hard disk drives, optical drives, solid-state drives, various types of random access memory (RAM), various types of read-only memory (ROM), neural networks, other computer-readable storage media (also referred to as processor-readable storage media), or the like, or any combination thereof. Memory 1102 may be utilized to store information, including computer-readable instructions that are utilized by CPU 1114 to perform actions, including those of embodiments described herein.

Memory 1102 may have stored thereon control module(s) 1104. The control module(s) 1104 may be configured to implement and/or perform some or all of the functions of the systems or components described herein. Memory 1102 may also store other programs and data 1110, which may include rules, databases, application programming interfaces (APIs), software containers, nodes, pods, clusters, node groups, control planes, software defined data centers (SDDCs), microservices, virtualized environments, software platforms, cloud computing service software, network management software, network orchestrator software, network functions (NF), artificial intelligence (AI) or machine learning (ML) programs or models to perform the functionality described herein, user interfaces, operating systems, other network management functions, other NFs, etc.

Network connections 1122 are configured to communicate with other computing devices to facilitate the functionality described herein. In various embodiments, the network connections 1122 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 1118 may include a video interface, other data input or output interfaces, or the like. Other computer-readable media 1120 may include other types of stationary or removable computer-readable media, such as removable flash drives, external hard drives, or the like.

The various embodiments described above may be combined to provide further embodiments. These and other changes may be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
receiving, by a cellular network health monitoring software tool, a natural language query from an agent of a mobile operator operating a fifth or later generation cellular network regarding operational status of a network function on the fifth or later generation cellular network;
vectorizing, by the cellular network health monitoring software tool, the natural language query through vector embedding such that the query is standardized;
determining whether the standardized query is cached;
performing, in response to determining whether the standardized query is cached:
retrieving, based on determining that the standardized query is cached, a cached response of previously generated code from a network status query database; or
applying, based on determining that the standardized query is not cached, a generative artificial intelligence model to the natural language query such that newly generated code is generated; and
presenting, via the graphical user interface to the agent of the mobile operator, a response to executing the previously generated code from the cached response or the newly generated code such that a status of the network function is indicated.

2. The method of claim 1, further comprising applying a data input layer that receives data for processing by the cellular network health monitoring software tool.

3. The method of claim 2, wherein the data input layer comprises a user input interface that receives the natural language query or a log file interface that receives network log data.

4. The method of claim 1, further comprising applying a pre-processing layer that transforms log data for subsequent analysis by a modeling layer.

5. The method of claim 4, wherein the pre-processing layer comprises:
a data cleaning operation that removes errors from the log data;
a data storage operation that structures the cleaned log data into a dataframe for efficient processing; or
a pattern mining operation that identifies recurring patterns in the log data.

6. The method of claim 1, wherein the previously generated code from the cached response or the newly generated code is executed by a modeling layer.

7. The method of claim 6, wherein the modeling layer comprises a code generation operation or a code execution operation.

8. The method of claim 7, wherein the code generation operation comprises:
a caching operation that performs text embedding on the standardized query such that semantic meaning is captured in a vector space;
a caching operation that calculates a similarity score between the standardized query and cached queries such that similar past queries are identified;
a smart search operation that performs named entity recognition on the standardized query such that a recognized name from the query is identified; or
a large language model-based code generation operation that generates a dataframe or chart based on the standardized query at least in part by translating the query into executable code.

9. The method of claim 6, wherein the modeling layer comprises:
a code testing operation that removes jailbreaking attempts, unsafe scripts, or non-whitelisted libraries such that a safety level of executing code is improved;
a code execution operation that runs the previously generated code or the newly generated code on the network log data; or
a cache updating operation that stores the standardized query and corresponding generated code for future use.

10. The method of claim 1, further comprising applying a graphical user interface layer that presents the response indicating the status of the network function to the agent of the mobile operator.

11. The method of claim 10, wherein the graphical user interface layer comprises:
a network function selection prompt;
a segmentation order selection prompt;
a time window selection prompt;
a domain name system selection prompt; or
a data source selection prompt.

12. The method of claim 10, wherein the graphical user interface layer comprises a heat map that visually represents the status of the network function indicated in the response.

13. The method of claim 12, wherein the heat map is indexed along one dimension by date or by location of a data center.

14. The method of claim 10, wherein the graphical user interface layer displays the original natural language query.

15. The method of claim 10, wherein the graphical user interface layer displays a chart indicating a pass rate per location for the network function.

16. The method of claim 10, wherein the graphical user interface layer comprises:
a feedback prompt asking whether the response was helpful; or
a chatbot dialogue interface for further queries.

17. A non-transitory computer-readable medium that has instructions stored thereon that, when executed by at least one physical computing processor, cause a computing device to perform operations comprising:
receiving, by a cellular network health monitoring software tool, a natural language query from an agent of a mobile operator operating a fifth or later generation cellular network regarding operational status of a network function on the fifth or later generation cellular network;
vectorizing, by the cellular network health monitoring software tool, the natural language query through vector embedding such that the query is standardized;
determining whether the standardized query is cached;
performing, in response to determining whether the standardized query is cached:
retrieving, based on determining that the standardized query is cached, a cached response of previously generated code from a network status query database; or
applying, based on determining that the standardized query is not cached, a generative artificial intelligence model to the natural language query such that newly generated code is generated; and
presenting, via the graphical user interface to the agent of the mobile operator, a response to executing the previously generated code from the cached response or the newly generated code such that a status of the network function is indicated.

18. The non-transitory computer-readable medium of claim 17, wherein the previously generated code from the cached response or the newly generated code is executed by a modeling layer.

19. A system comprising:
at least one physical computing processor of a computing device; and
a non-transitory computer-readable medium that has instructions stored thereon that, when executed by the at least one physical computing processor, cause the computing device to perform operations comprising:
receiving, by a cellular network health monitoring software tool, a natural language query from an agent of a mobile operator operating a fifth or later generation cellular network regarding operational status of a network function on the fifth or later generation cellular network;
vectorizing, by the cellular network health monitoring software tool, the natural language query through vector embedding such that the query is standardized;
determining whether the standardized query is cached;
performing, in response to determining whether the standardized query is cached:
retrieving, based on determining that the standardized query is cached, a cached response of previously generated code from a network status query database;
applying, based on determining that the standardized query is not cached, a generative artificial intelligence model to the natural language query such that newly generated code is generated; and
presenting, via the graphical user interface to the agent of the mobile operator, a response to executing the previously generated code from the cached response or the newly generated code such that a status of the network function is indicated.

20. The system of claim 19, wherein the previously generated code from the cached response or the newly generated code is executed by a modeling layer.
